(19) United States
(12) Patent Application Publication
(10) Pub. No.: US 2026/0218037 A1
(43) Pub. Date: Jul. 30, 2026

(54) COMPOSITIONS AND METHODS OF REMOVING IRON SULFIDE SCALES FROM LOW PRESSURE GAS WELLS

(71) Applicant: Saudi Arabian Oil Company, Dhahran (SA)

(72) Inventors: Qiwei Wang, Dhahran (SA); Jairo Leal Jauregui, Udhailiyah (SA); Tao Chen, Dhahran (SA); Husain H. Bar, Dammam (SA); Waleed K. Khnaifir, Al-Hasa (SA)

(21) Appl. No.: 19/038,874

(22) Filed: Jan. 28, 2025

(51) Int. Cl. C09K 8/532; C09K 8/54; E21B 41/02

(52) U.S. Cl. CPC C09K 8/532; C09K 8/54; E21B 41/02; C09K 2208/32

(57) ABSTRACT

Described herein is a composition which includes a foaming agent, and one or more of an iron sulfide dissolver and a corrosion inhibitor. The composition is capable of reducing a bulk density and hydrostatic pressure of a fluid in a low-pressure gas well. Also described herein are methods of removing an iron sulfide scale from a low-pressure gas well using the composition.

### TECHNICAL FIELD

The present disclosure relates to compositions, more particularly, to compositions for removing iron sulfide (FeS) scales. The present disclosure also provides methods for using the composition, more particularly, to methods of removing iron sulfide scales from low pressure gas wells using the compositions.

### BACKGROUND

Iron sulfide (FeS) surface deposition is a persistent scaling issue in the oil and gas industry, particularly in sour gas wells. Ferrous ions react with sour gas to form iron sulfide deposits in downhole tubulars, which can negatively impact well deliverability, hinder well surveillance, and restrict well intervention activities.

Conventional scale dissolvers and corrosion inhibitors used for batch treatments face challenges in low-pressure gas wells. These wells are difficult to resume production after treatment or take a prolonged period to return to pre-treatment production levels. This difficulty arises due to insufficient bottom-hole pressure, coupled with the high specific gravity of FeS scale solids. These solids tend to segregate downhole, making retrieval challenging, especially for spend dissolvers containing suspended high-density FeS particles.

This disclosure describes methods and materials to treat iron sulfide deposit issue in these low-pressure wells by using dual- or multi-functional chemicals. This dual- or multi-function is achieved by formulating the high temperature foaming agent, the surfactant which facilitates foam formation, into the FeS dissolvers or sour corrosion inhibitors. When these novel products are used in treating low pressure wells, foam will be formed in the spent chemicals after treatment when production is resumed, with the mixing of produced gas and spent chemical, significantly reducing the bulk density of fluid in the tubing column and the hydrostatic pressure. Therefore, the wells can be easily revived or returned to (for corrosion inhibitor treatment) or exceed (for scale dissolution treatment) the pre-treatment gas productivity.

This method is far superior in scaling and corrosion control to the current practices in:
Improving iron sulfide control in gas wells;
Lowering OPEX on chemical treatment;
Low complexity; easy to deploy and adjust the treatment program; and
Increased productivity in low pressure gas wells.

Accordingly, there is a need to develop compositions and methods for effectively removing FeS scales from low-pressure gas wells. Such compositions and methods should address the limitations of existing treatments by providing enhanced dissolution efficiency, better handling of high-density particles, and minimizing disruptions to well operations. These improvements should also prioritize environmental safety and operational cost-effectiveness to ensure widespread applicability in the industry.

### SUMMARY

In an exemplary embodiment, a composition includes a foaming agent, and one or more chemicals selected from the group consisting of an iron sulfide dissolver, and a corrosion inhibitor. In some embodiments, the composition is capable of reducing a bulk density and hydrostatic pressure of a fluid in a low-pressure gas well.

In some embodiments, the composition includes about 0.1 to about 50 wt. % of a foaming agent; about 0.1 to about 70 wt. % of an iron sulfide dissolver; and about 0.1 to about 10 wt. % of a corrosion inhibitor, each wt. % based on a total weight of the composition.

In some embodiments, the composition includes about 1 to about 30 wt. % of a foaming agent; about 1 to about 60 wt. % of an iron sulfide dissolver; and about 1 to about 10 wt. % of a corrosion inhibitor.

In some embodiments, the composition includes about 1 to about 30 wt. % of a foaming agent; about 1 to about 50 wt. % of an iron sulfide dissolver; and about 1 to about 5 wt. % of a corrosion inhibitor.

In some embodiments, the foaming agent is a fatty betaine or sulfobetaine composition.

In some embodiments, the foaming agent is selected from sodium lauryl sulfate, sodium dodecylbenzenesulfonate, cocamidopropyl betaine, cocamidopropyl hydroxyl sulfobetaine, cocamidopropyl hydroxy sultaine, or combinations thereof.

In some embodiments, the iron sulfide dissolver is selected from an acid-based dissolver, a chelating agent, an oxidizing agent, a thiocarbamate compound, or combinations thereof.

In some embodiments, the iron sulfide dissolver is a polyamino polycarboxylic chelating agent, a quaternary ammonium salt, or a quaternary phosphonium salt.

In some embodiments, the iron sulfide dissolver is a polyamino polycarboxylic chelating agent selected from EDTA, HEDTA, DTPA, GLDA, or THPS (tetrakis hydroxymethyl phosphonium sulfate).

In some embodiments, the corrosion inhibitor is selected from the group consisting of a fatty amine, a fatty diamine, a fatty acid, an imidazoline, a phosphate ester, an amide, a thioamide, a thiol, a thioalcohol, and combinations thereof.

In some embodiments, the corrosion inhibitor is an organic compound that contains unsaturated bonds or atoms, such as N, O, S, selected from long chain primary amines, imidazolines, fatty acids and phosphate esters.

In an exemplary embodiment, a method of removing an iron sulfide scale from a low-pressure gas well includes introducing, separately or together, a foaming agent, and one or more chemicals selected from the group consisting of an iron sulfide dissolver, and a corrosion inhibitor, into a bottom of a low-pressure gas well comprising a fluid to form a mixture; contacting the mixture with the iron sulfide scale present in the low-pressure gas well, thereby dissolving at least a portion of the iron sulfide scale in the mixture; and removing the at least a portion of the iron sulfide scale dissolved in the mixture by withdrawing the mixture from the low-pressure gas well.

In some embodiments, the iron sulfide scale includes at least one of pyrite, pyrrhotite, troilite, greigite, mackinawite, marcasite, or combinations thereof.

In some embodiments, the iron sulfide scale includes about 0.1 to about 85 wt. % of pyrrhotite; about 5 to about 70 wt. % of pyrite; about 0.1 to about 10 wt. % of troilite; about 0.5 to about 30 wt. % of marcasite; about 0.1 to about 10 wt. % of greigite; and about 0.01 to about 5 wt. % of mackinawite, each wt. % based on a total weight of the iron sulfide scale present in the low-pressure gas well.

In some embodiments, the iron sulfide scale includes about 5 to about 70 wt. % of pyrite; and about 0.5 to about 30 wt. % of marcasite, each wt. % based on a total weight of the iron sulfide scale present in the low-pressure gas well.

In some embodiments, the low-pressure gas well further includes one or more minerals selected from ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, olivine (fayalite), augite, hedenbergite, biotite, hornblende, garnet (almandine), vivianite, jarosite, glauconite, iron chlorite, native iron, and calcite.

In some embodiments, the fluid includes gaseous hydrocarbons or liquid hydrocarbons.

In some embodiments, after removing the at least a portion of the iron sulfide scale, a bulk density of the fluid in the low-pressure gas well is reduced by at least about 50% based on an initial bulk density of the fluid before the introduction, separately or together, of the foaming agent, the iron sulfide dissolver, and the corrosion inhibitor.

In some embodiments, after removing the at least a portion of the iron sulfide scale, a hydrostatic pressure of the fluid in the low-pressure gas well is reduced by at least about 50% based on an initial hydrostatic pressure of the fluid before the introduction, separately or together, of the foaming agent, the iron sulfide dissolver, and the corrosion inhibitor.

In some embodiments, the introducing is performed by pumping, separately or together, one or more selected from the group consisting of the foaming agent, the iron sulfide dissolver, and the corrosion inhibitor, at a wellhead of the low-pressure gas well or by displacing the fluid at the bottom of the low-pressure gas well, separately or together, with the foaming agent, the iron sulfide dissolver, and the corrosion inhibitor via a coiled tubing.

### BRIEF DESCRIPTION OF THE DRAWINGS

FIG. 1 illustrates the formation and transformation sequence of iron sulfide (FeS) in gas wells with high hydrogen sulfide (H₂S) content, according to certain embodiments of the present disclosure.

FIG. 2 illustrates average scale composition for over 100 scale deposits analyzed from some high sour (H₂S=0.5-8 mol %) gas, according to certain embodiments of the present disclosure.

FIG. 3 illustrates compositions of various deposits from bailer samples collected at different depths within downhole tubulars, according to certain embodiments of the present disclosure.

FIG. 4 is a flow diagram illustrating a method of removing an iron sulfide scale from a low-pressure gas well, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “particle size” and “pore size” are thought of as the lengths or longest dimensions of a particle and of a pore opening, respectively.

As used herein, the term “chelating agent” refers to any chemical compound, complex, or composition capable of forming a chemical bond with a metal, e.g., iron, to create a stable complex in which the metal is part of a ring structure. An organic ligand that acts as a chelating agent is also referred to as a chelator, and the resulting metal-containing complex is known as a chelate.

As used herein, the term “bottom-hole” refers to the section of a wellbore at or near the depth where hydraulic fracture is initiated from.

As used herein, the term “bottom pressure,” or “bottom-hole pressure” refers to the pressure in a wellbore at or near the depth where hydraulic fracture is initiated from. When friction loss is negligible, the bottom pressure equals fracture pressure.

As used herein, the term “formation” refers to a body of rock that is sufficiently distinctive and continuous. Hydrocarbon often accumulates and stored in sandstone formation, carbonate formation and shale formation.

As used herein, the term “fluid” may be, but is not limited to, a gas, a liquid, an emulsion, a slurry, or a stream of solid particles that has flow characteristics similar to liquid flow. For example, the fluid can include water-based liquids having chemical additives (e.g., spend chemicals). Further, the chemical additives can include, but are not limited to, acids, gels, chloride, inorganic salts, surfactants, and so forth.

As used herein, the term “fatty” describes a compound with a long-chain (linear) hydrophobic portion made up of hydrogen and anywhere from 6 to 26, 8 to 24, 10 to 22, 12 to 20, 14 to 18 carbon atoms, which may be fully saturated or partially unsaturated, and optionally attached to a polar functional group such as a hydroxyl group, an amine group, or a carboxyl group (e.g., carboxylic acid). Fatty alcohols, fatty amines, fatty acids, fatty esters, and fatty amides are examples of materials which contain a fatty portion, and are thus considered “fatty” compounds herein. For example, stearic acid, which has 18 carbons total (a fatty portion with 17 carbon atoms and 1 carbon atom from the —COOH group), is considered to be a fatty acid having 18 carbon atoms herein.

As used herein, the term “substituent group,” “suitable substituent,” or “R” includes, but is not limited to, halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, arylalkyl or heteroarylalkyl groups, arylalkoxy or heteroarylalkoxy groups, carboxyl groups, heterocyclic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

As used herein, the term “alkyl” refers to a linear or branched hydrocarbon radical which may contain up to 20 carbon atoms. The alkyl group may be C₁ to C₆ alkyl, or C₁ to C₄ alkyl, or C₁ to C₃ alkyl, or C₁ to C₂ alkyl. Non-limiting examples of such alkyl fragments include methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl.

As used herein, the term “alkenyl” refers to a straight or branched hydrocarbon radical which may contain up to 26 carbon atoms and have one or more carbon-carbon double bonds. Non-limiting examples of such alkenyl groups include, but are not limited to, ethenyl, 1-propenyl, 2-propenyl (allyl), isopropenyl, 2-methyl-1-propenyl, 1-butenyl, and 2-butenyl. Alkenyl groups can be unsubstituted or substituted by one or more suitable substituents, as defined above.

As used herein, the term “alkynyl” refers to a straight or branched hydrocarbon radical, which may contain up to 26 carbon atoms and have one or more carbon-carbon triple bonds. Alkynyl groups include, but are not limited to, ethynyl, propynyl, and butynyl. Alkynyl groups can be unsubstituted or substituted by one or more suitable substituents, as defined above.

As used herein, the term “alkoxy” refers to an alkyl group, as defined herein, appended to the parent molecular moiety through an oxygen atom.

As used herein, the term “alkoxylated” or “alkoxylate” refers to compounds containing a (poly)ether group (i.e., (poly)oxyalkylene group) derived from reaction with, oligomerization of, or polymerization of one or more alkylene oxides having 2 to 4 carbon atoms, and specifically includes (poly)oxyethylene (derived from ethylene oxide, EO), (poly)oxypropylene (derived from propylene oxide, PO), and (poly)oxybutylene (derived from butylene oxide, BO), as well as mixtures thereof.

As used herein, “alkanoyloxy” groups are alkanoyl groups that are bound to oxygen (—O—C(O)-alkyl), for example, acetyloxy, propionyloxy, butyryloxy, isobutyryloxy, pivaloyloxy, valeryloxy, hexanoyloxy, octanoyloxy, lauroyloxy, and stearoyloxy. “Alkoxycarbonyl” substituents are alkoxy groups bound to C═O (e.g., —C(O)—O-alkyl), for example methyl ester, ethyl ester, and pivaloyl ester substitution where the carbonyl functionality is bound to the rest of the compound.

The term “carbonyl,” “(C═O)” or “—C(O)—” (as used in phrases such as alkylcarbonyl, alkyl-(C═O)— or alkoxycarbonyl) refers to the joinder of the >C═O moiety to a second moiety such as an alkyl or amino group (i.e., an amido group). Alkoxycarbonylamino (i.e., alkoxy (C═O)—NH—) refers to an alkyl carbamate group. The carbonyl group is also equivalently defined herein as (C═O). Alkylcarbonylamino refers to groups such as acetamide.

As used herein, the term “aryl” refers to an aromatic group containing only carbon in the aromatic ring(s), such as phenyl, biphenyl, naphthyl, anthracenyl, and the like.

The term “heteroaryl” or “heteroaromatic,” employed alone or in combination with other terms, refers to a monocyclic or polycyclic aromatic heterocycle having at least one heteroatom ring member selected from boron, phosphorus, sulfur, oxygen and nitrogen. In some embodiments, the heteroaryl ring has 1, 2, 3 or 4 heteroatom ring members independently selected from nitrogen, sulfur and oxygen. In some embodiments, any ring-forming N in a heteroaryl moiety can be an N-oxide. In some embodiments, the heteroaryl has 5-14 ring atoms including carbon atoms and 1, 2, 3 or 4 heteroatom ring members independently selected from nitrogen, sulfur and oxygen. In some embodiments, the heteroaryl has 5-14, or 5-10 ring atoms including carbon atoms and 1, 2, 3 or 4 heteroatom ring members independently selected from nitrogen, sulfur and oxygen. In some embodiments, the heteroaryl has 5-6 ring atoms and 1 or 2 heteroatom ring members independently selected from nitrogen, sulfur and oxygen. In some embodiments, the heteroaryl is a five-membered or six-membered heteroaryl ring. In other embodiments, the heteroaryl is an eight-membered, nine-membered or ten-membered fused bicyclic heteroaryl ring. Example heteroaryl groups include, but are not limited to, pyridinyl (pyridyl), pyrimidinyl, pyrazinyl, pyridazinyl, pyrrolyl, pyrazolyl, azolyl, oxazolyl, thiazolyl, imidazolyl, furanyl, thiophenyl, quinolinyl, isoquinolinyl, naphthyridinyl (including 1,2-, 1,3-, 1,4-, 1,5-, 1,6-, 1,7-, 1,8-, 2,3- and 2,6-naphthyridine), indolyl, benzothiophenyl, benzofuranyl, benzisoxazolyl, imidazo[1,2-b]thiazolyl, purinyl, and the like.

A five-membered heteroaryl ring is a heteroaryl group having five ring atoms wherein one or more (e.g., 1, 2 or 3) ring atoms are independently selected from N, O and S. Exemplary five-membered ring heteroaryls include thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl and 1,3,4-oxadiazolyl.

A six-membered heteroaryl ring is a heteroaryl group having six ring atoms wherein one or more (e.g., 1, 2 or 3) ring atoms are independently selected from N, O and S. Exemplary six-membered ring heteroaryls are pyridyl, pyrazinyl, pyrimidinyl, triazinyl and pyridazinyl.

The term “cycloalkyl,” employed alone or in combination with other terms, refers to a non-aromatic hydrocarbon ring system (monocyclic, bicyclic or polycyclic), including cyclized alkyl and alkenyl groups. The term “Cₙ-Cₘ cycloalkyl” refers to a cycloalkyl that has n to m ring member carbon atoms. Cycloalkyl groups can include mono- or polycyclic (e.g., having 2, 3 or 4 fused rings) groups and spirocycles. Cycloalkyl groups can have 3, 4, 5, 6, 7, 8, 9, 10, 11, 12, 13, or 14 ring-forming carbons (C₃-C₁₄). In some embodiments, the cycloalkyl group has 3 to 14 members, 3 to 10 members, 3 to 6 ring members, 3 to 5 ring members, or 3 to 4 ring members. In some embodiments, the cycloalkyl group is monocyclic. In some embodiments, the cycloalkyl group is monocyclic or bicyclic. In some embodiments, the cycloalkyl group is a C₃₋₆ monocyclic cycloalkyl group. Ring-forming carbon atoms of a cycloalkyl group can be optionally oxidized to form an oxo or sulfido group. Cycloalkyl groups also include cycloalkylidenes. In some embodiments, cycloalkyl is cyclopropyl, cyclobutyl, cyclopentyl or cyclohexyl. Also included in the definition of cycloalkyl are moieties that have one or more aromatic rings fused (i.e, having a bond in common with) to the cycloalkyl ring, e.g., benzo or thienyl derivatives of cyclopentane, cyclohexane and the like. A cycloalkyl group containing a fused aromatic ring can be attached through any ring-forming atom including a ring-forming atom of the fused aromatic ring. Examples of cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, bicyclo[1.1.1]pentanyl, bicyclo[2.1.1]hexanyl, and the like. In some embodiments, the cycloalkyl group is cyclopropyl, cyclobutyl, cyclopentyl, or cyclohexyl.

The term “heterocycloalkyl,” employed alone or in combination with other terms, refers to a non-aromatic ring or ring system, which may optionally contain one or more alkenylene groups as part of the ring structure, which has at least one heteroatom ring member independently selected from boron, nitrogen, sulfur oxygen and phosphorus, and which has 4-14 ring members, 4-10 ring members, 4-7 ring members, or 4-6 ring members. Included within the term “heterocycloalkyl” are monocyclic 4-, 5-, 6- and 7-membered heterocycloalkyl groups. Heterocycloalkyl groups can include mono- or bicyclic or polycyclic (e.g., having two or three fused or bridged rings) ring systems or spirorcycles. In some embodiments, the heterocycloalkyl group is a monocyclic group having 1, 2 or 3 heteroatoms independently selected from nitrogen, sulfur and oxygen. Ring-forming carbon atoms and heteroatoms of a heterocycloalkyl group can be optionally oxidized to form an oxo or sulfido group or other oxidized linkage (e.g., C(O), S(O), C(S) or S(O)₂, N-oxide etc.) or a nitrogen atom can be quaternized. The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the heterocycloalkyl ring, e.g., benzo or thienyl derivatives of piperidine, morpholine, azepine, etc. A heterocycloalkyl group containing a fused aromatic ring can be attached through any ring-forming atom including a ring-forming atom of the fused aromatic ring. Examples of heterocycloalkyl groups include azetidinyl, azepanyl, dihydrobenzofuranyl, dihydrofuranyl, dihydropyranyl, morpholino, 3-oxa-9-azaspiro[5.5]undecanyl, 1-oxa-8-azaspiro[4.5]decanyl, piperidinyl, piperazinyl, oxopiperazinyl, pyranyl, pyrrolidinyl, quinuclidinyl, tetrahydrofuranyl, tetrahydropyranyl, 1,2,3,4-tetrahydroquinolinyl, tropanyl, 4,5,6,7-tetrahydrothiazolo[5,4-c]pyridinyl, and thiomorpholino.

At certain places, the definitions or embodiments refer to specific rings (e.g., an azetidine ring, a pyridine ring). Unless otherwise indicated, these rings can be attached to any ring member provided that the valency of the atom is not exceeded. For example, an azetidine ring may be attached at any position of the ring, whereas an azetidin-3-yl ring is attached at the 3-position.

The term “halo” or “halogen,” as used herein, refers to a fluoro, chloro, bromo or iodo radical. Likewise, the term “halide” refers to fluoride, chloride, bromide, iodide or the like.

The term “oxo,” as used herein, refers to a double bonded oxygen (═O) radical wherein the bond partner is a carbon atom. Such a radical can also be thought as a carbonyl group.

The term “-ene” as used as a suffix as part of another group denotes a bivalent radical in which a hydrogen atom is removed from each of two terminal carbons of the group. For example, alkylene denotes a bivalent alkyl group such as methylene (—CH₂—) or ethylene (—CH₂CH₂—). For clarity, addition of the -ene suffix is not intended to alter the definition of the principal word other than denoting a bivalent radical. Thus, continuing the example above, alkylene denotes an optionally substituted linear or branched bivalent hydrocarbon radical.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the foregoing, one objective of the present disclosure is to provide a composition for removing iron sulfide (FeS) scales. A second objective of the present disclosure is to provide a method of removing iron sulfide scales from low pressure gas wells using the composition.

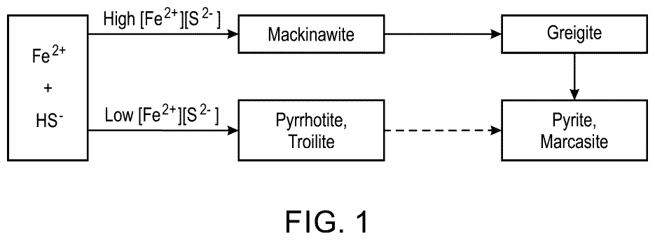

Iron sulfide deposition on equipment surfaces is a persistent and costly issue in the oil and gas industry, particularly in high-temperature sour (H₂S) gas wells completed with carbon steel. Corrosion of carbon steel generates ferrous ions (Fe²⁺), which readily react with dissolved sulfide, either as H₂S or HS, to form FeS scales. Initially, FeS may form as mackinawite, a highly soluble and less stable phase compared to other FeS minerals. Over time, mackinawite can be transformed into more stable FeS phases, as illustrated in FIG. 1. For instance, mackinawite may transition into more stable phases such as pyrrhotite and/or troilite or convert into greigite. Subsequently, these phases, including pyrrhotite, troilite, and greigite, may further transform into pyrite and/or marcasite.

The characteristics of iron sulfide minerals commonly found in oil and gas production systems are summarized in Table 1 below.

TABLE 1
Characteristics of iron sulfide minerals

| Mineral | Formula | Structure | Density (g/cm³) |
|---|---|---|---|
| Mackinawite | Fe₁₊ₓS | Tetragonal | 4.17 |
| Pyrrhotite | Fe₁₋ₓS | Monoclinic, hexagonal | 4.61 |
| Troilite | FeS | Hexagonal | 4.83 |
| Greigite | Fe₃S₄ | Cubic | 4.05 |
| Pyrite | FeS₂ | Cubic | 5.01 |
| Marcasite | FeS₂ | Orthorhombic | 4.91 |

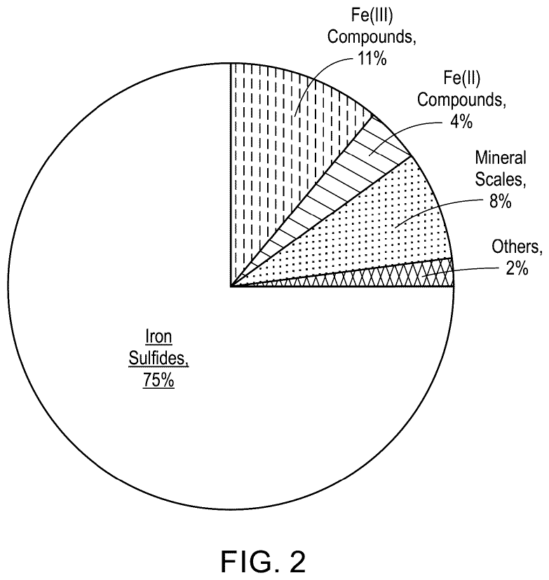

The deposits in the oil and gas production systems may also contain other scale minerals, including iron oxides, calcium carbonate, and barium sulfate. Referring to FIG. 2, the average scale composition from high-sour gas wells with hydrogen sulfide (H₂S) content ranging from about 0.5 to about 8 mol % consists of about 75 wt. % iron sulfides, about 11 wt. % Fe(III) compounds, about 4 wt. % Fe(II) compounds, about 8 wt. % mineral scales, and others. For example, the Fe(III) compounds may include, but are not limited to, hematite, magnetite, goethite, akaganeite, and lepidocrocite. For example, the Fe(II) compounds may include, but are not limited to, siderite, ferrous chloride tetrahydrate, and wüstite. Additionally, for example, the mineral scales may include, but are not limited to, calcite, dolomite, anhydrite, gypsum, and barite. Other solids present in the deposits may include, but are not limited to, elemental sulfur, quartz, alumina, and clays.

Generally speaking, FeS deposition in sour gas and oil wells is a corrosion induced scale problem. The use of a scale inhibitor to prevent scale formation is less effective because no threshold FeS inhibitor is currently available, and different types of scale can be deposited concurrently.

The cost-effective mitigation strategies are:
Using corrosion inhibitor to protect carbon steel metallurgy and reducing the ferrous ions (Fe²⁺) generated by corrosion reaction;
Removing deposits using chemical or mechanical or a combination of both methods.

Both approaches have been used to treating FeS (or FeS dominated) deposits on downhole tubulars in sour gas wells. Removing deposits with chemical dissolver is a batch treatment, where dissolver is pumped from wellhead and soaked for hours to days before flowback. For wells without downhole capillary injection line installed, batch treatment is also the preferred treatment method. The soaking time for corrosion inhibitor treatment can be couple of hours to overnight.

However, the batch treatments using conventional scale dissolvers and corrosion inhibitor chemicals face challenges for low-pressure gas wells. The wells are difficult to resume production after treatment or take a long time to achieve the pre-treatment production level, due to there is insufficient bottom pressure to push the treatment fluids, especially for the spend dissolvers which contain suspended high density FeS particles (see FIG. 1).

Even without the treatment mentioned above, many matured gas wells have liquid loading issues, with produce water and/or hydrocarbon condensate accumulated at the bottom of wells, which block the gas flow and reduce the well productivity.

This disclosure describes methods and materials to treat iron sulfide deposit issue in these low-pressure wells by using dual- or multi-functional chemicals. This dual- or multi-function is achieved by formulating the foaming agent, the surfactant which facilitate foam formation, into the FeS dissolvers or sour corrosion inhibitors. When these novel products are used in treating low pressure wells, foam will be formed in the spent chemicals after treatment when production is resumed, with the mixing of produced gas and spent chemical, significantly reducing the bulk density of fluid in the tubing column and the hydrostatic pressure. Therefore, the wells can be easily revived or return to pre-treatment productivity.

These products can be formulated with foaming agent with dissolver chemicals or with corrosion inhibition chemicals to form dual-functional property. They can also be formulated with all three type of compounds, i.e., foaming agent, dissolver agent and corrosion inhibitor compound, together to form triple-functional property.

The products can be applied for subsurface treatment by either pumping at wellhead using a pumping truck or coiled tubing to displace the product at the designed depth.

The dual-function foaming/corrosion inhibitor product is used, preferably, to wells without or with a very small amount of FeS formed on downhole tubular. The dual-function foaming/dissolver product is used for wells with heavy FeS deposition. The tri-functional products are to be applied to wells with mild FeS scale amount.

Alternatively, although not ideal, foaming chemical can be applied first to the bottom of gas wells, then followed by adding scale dissolver or corrosion inhibitor or the combo product of both. Foaming chemical can also be added during the pumping of other chemicals.

Using conventional scale dissolvers and corrosion inhibitor chemicals for batch treatments face significant challenges in low-pressure gas wells. The wells are often difficult to resume gas productivity after treatment or take a long time to reach pre-treatment production levels due to insufficient bottom pressure to push the treatment fluids, particularly the spent dissolvers containing suspended high-density FeS particles. In some cases, downhole treatments are limited due to severe well depletion scenarios. When these novel products described in this disclosure are used in treating low pressure wells, foam will be formed in the spent chemicals after treatment when production is resumed, with the mixing of produced gas and spent chemical, significantly reducing the bulk density of fluid in the tubing column and the hydrostatic pressure. Therefore, the wells can be easily revived or return to pre-treatment productivity.

The combined chemical package proposed in this invention can be used for treating low-pressure gas wells, differentiating from conventional iron sulfide scale dissolvers or sour corrosion inhibitor used for downhole batch treatment. The scale and/or corrosion treatment can be also removing the accumulated produce water and/or hydrocarbon condensate at the wellbore regions. It will significantly reduce treatment cost and enhance gas production.

According to an aspect of the present disclosure, a composition for removing FeS scales comprises a foaming agent and one or more chemicals selected from dissolver agents or corrosion inhibitors. In some embodiments, the dissolver agent includes an iron sulfide dissolver. In some embodiments, the corrosion inhibitor is a sour corrosion inhibitor. Examples of the composition include a composition containing a foaming agent and a corrosion inhibitor; a composition containing a foaming agent and a corrosion inhibitor; or a composition containing a foaming agent, an iron sulfide dissolver, and a corrosion inhibitor. According to an aspect of the present disclosure, a composition for removing FeS scales comprises a foaming agent and one or more chemicals selected from iron sulfide dissolvers or corrosion inhibitors.

In some embodiments, the composition for removing FeS scales contains about 0.1 to about 50 wt. % of a foaming agent base on a total weight of the composition, such as about 0.5 to about 45 wt. %, about 5 to about 40 wt. %, about 10 to about 35 wt. %, about 15 to about 30 wt. %, about 20 to about 25 wt. %, or about 2 wt. %, about 7 wt. %, about 12 wt. %, about 17 wt. %, about 22 wt. %, about 27 wt. %, about 32 wt. %, about 37 wt. %, or about 42 wt. % based on the total weight of the composition.

In some embodiments, the composition for removing FeS scales contains about 0.1 to about 70 wt. % of a dissolver agent based on the total weight of the composition, such as about 0.5 to about 65 wt. %, about 5 to about 60 wt. %, about 10 to about 55 wt. %, about 15 to about 50 wt. %, about 20 to about 45 wt. %, about 25 to about 40 wt. %, about 30 to about 35 wt. %, or about 2 wt. %, about 7 wt. %, about 12 wt. %, about 17 wt. %, about 22 wt. %, about 27 wt. %, about 32 wt. %, about 37 wt. %, about 42 wt. %, about 47 wt. %, about 52 wt. %, about 57 wt. %, about 62 wt. %, or about 67 wt. % based on the total weight of the composition.

In some embodiments, the composition for removing FeS scales contains about 0.1 to about 70 wt. % of an iron sulfide dissolver based on the total weight of the composition, such as about 0.5 to about 65 wt. %, about 5 to about 60 wt. %, about 10 to about 55 wt. %, about 15 to about 50 wt. %, about 20 to about 45 wt. %, about 25 to about 40 wt. %, about 30 to about 35 wt. %, or about 2 wt. %, about 7 wt. %, about 12 wt. %, about 17 wt. %, about 22 wt. %, about 27 wt. %, about 32 wt. %, about 37 wt. %, about 42 wt. %, about 47 wt. %, about 52 wt. %, about 57 wt. %, about 62 wt. %, or about 67 wt. % based on the total weight of the composition.

In some embodiments, the composition for removing FeS scales contains about 0.1 to about wt. % of a corrosion inhibitor based on the total weight of the composition, such as about 0.5 to about 9 wt. %, about 1 to about 8 wt. %, about 2 to about 7 wt. %, about 3 to about 6 wt. %, about 4 to about 5 wt. %, or about 0.3 wt. %, about 1.3 wt. %, about 2.3 wt. %, about 3.3 wt. %, about 4.3 wt. %, about 5.3 wt. %, about 6.3 wt. %, about 7.3 wt. %, about 8.3 wt. %, or about 9.3 wt. % based on the total weight of the composition.

In some embodiments, the composition for removing FeS scales contains about 1 to about 30 wt. % of a foaming agent and about 1 to about 10 wt. % of a corrosion inhibitor. In some embodiments, the composition for removing FeS scales contains about 5 to about 25 wt. % of a foaming agent and about 1 to about 8 wt. % of a corrosion inhibitor. In some embodiments, the composition for removing FeS scales contains about 10 to about 20 wt. % of a foaming agent and about 2 to about 6 wt. % of a corrosion inhibitor. In some embodiments, the composition for removing FeS scales contains about 10 to about 20 wt. % of a foaming agent and about 3 to about 5 wt. % of a corrosion inhibitor. In some embodiments, the composition for removing FeS scales contains about 10 to about 20 wt. % of a foaming agent and about 3 to about 5 wt. % of a corrosion inhibitor. In some embodiments, the composition for removing FeS scales contains about 10 to about 20 wt. % of a foaming agent and about 3 to about 5 wt. % of a corrosion inhibitor. In some embodiments, the composition for removing FeS scales contains about 15 wt. % of a foaming agent and about 5 wt. % of a corrosion inhibitor.

In some embodiments, the composition for removing FeS scales contains about 1 to about wt. % of a foaming agent and about 1 to about 60 wt. % of a dissolver agent. In some embodiments, the composition for removing FeS scales contains about 5 to about 25 wt. % of a foaming agent and about 5 to about 55 wt. % of a dissolver agent. In some embodiments, the composition for removing FeS scales contains about 10 to about 20 wt. % of a foaming agent and about 10 to about 50 wt. % of a dissolver agent. In some embodiments, the composition for removing FeS scales contains about 10 to about 20 wt. % of a foaming agent and about 15 to about 45 wt. % of a dissolver agent. In some embodiments, the composition for removing FeS scales contains about 10 to about 20 wt. % of a foaming agent and about 20 to about 40 wt. % of a dissolver agent. In some embodiments, the composition for removing FeS scales contains about 10 to about 20 wt. % of a foaming agent and about 25 to about 35 wt. % of a dissolver agent. In some embodiments, the composition for removing FeS scales contains about 15 wt. % of a foaming agent and about 30 wt. % of a dissolver agent.

In some embodiments, the composition for removing FeS scales contains about 1 to about 30 wt. % of a foaming agent and about 1 to about 60 wt. % of an iron sulfide dissolver. In some embodiments, the composition for removing FeS scales contains about 5 to about 25 wt. % of a foaming agent and about 5 to about 55 wt. % of an iron sulfide dissolver. In some embodiments, the composition for removing FeS scales contains about 10 to about 20 wt. % of a foaming agent and about 10 to about 50 wt. % of an iron sulfide dissolver. In some embodiments, the composition for removing FeS scales contains about 10 to about 20 wt. % of a foaming agent and about 15 to about 45 wt. % of an iron sulfide dissolver. In some embodiments, the composition for removing FeS scales contains about 10 to about 20 wt. % of a foaming agent and about 20 to about 40 wt. % of an iron sulfide dissolver. In some embodiments, the composition for removing FeS scales contains about 10 to about 20 wt. % of a foaming agent and about 25 to about 35 wt. % of an iron sulfide dissolver. In some embodiments, the composition for removing FeS scales contains about 15 wt. % of a foaming agent and about 30 wt. % of an iron sulfide dissolver.

In some embodiments, the composition for removing FeS scales contains about 1 to about 30 wt. % of a foaming agent, about 1 to about 60 wt. % of a dissolver agent, and about 1 to about 10 wt. % of a corrosion inhibitor. In some embodiments, the composition for removing FeS scales contains about 5 to about 25 wt. % of a foaming agent, about 5 to about 55 wt. % of dissolver agent, and about 1 to about 8 wt. % of a corrosion inhibitor. In some embodiments, the composition for removing FeS scales contains about 10 to about 20 wt. % of a foaming agent, about 10 to about 50 wt. % of dissolver agent, and about 2 to about 6 wt. % of a corrosion inhibitor. In some embodiments, the composition for removing FeS scales contains about 10 to about 20 wt. % of a foaming agent, about 15 to about 45 wt. % of dissolver agent, and about 3 to about 5 wt. % of a corrosion inhibitor. In some embodiments, the composition for removing FeS scales contains about 10 to about 20 wt. % of a foaming agent, about 20 to about 40 wt. % of dissolver agent, and about 3 to about 5 wt. % of a corrosion inhibitor. In some embodiments, the composition for removing FeS scales contains about 10 to about 20 wt. % of a foaming agent, about 25 to about 35 wt. % of dissolver agent, and about 3 to about 5 wt. % of a corrosion inhibitor. In some embodiments, the composition for removing FeS scales contains about 15 wt. % of a foaming agent, about 30 wt. % of dissolver agent, and about 5 wt. % of a corrosion inhibitor.

In some embodiments, the composition for removing FeS scales contains about 1 to about 30 wt. % of a foaming agent, about 1 to about 60 wt. % of an iron sulfide dissolver, and about 1 to about 10 wt. % of a corrosion inhibitor. In some embodiments, the composition for removing FeS scales contains about 5 to about 25 wt. % of a foaming agent, about 5 to about 55 wt. % of an iron sulfide dissolver, and about 1 to about 8 wt. % of a corrosion inhibitor. In some embodiments, the composition for removing FeS scales contains about 10 to about 20 wt. % of a foaming agent, about 10 to about 50 wt. % of an iron sulfide dissolver, and about 2 to about 6 wt. % of a corrosion inhibitor. In some embodiments, the composition for removing FeS scales contains about 10 to about 20 wt. % of a foaming agent, about 15 to about 45 wt. % of an iron sulfide dissolver, and about 3 to about 5 wt. % of a corrosion inhibitor. In some embodiments, the composition for removing FeS scales contains about 10 to about 20 wt. % of a foaming agent, about 20 to about 40 wt. % of an iron sulfide dissolver, and about 3 to about 5 wt. % of a corrosion inhibitor. In some embodiments, the composition for removing FeS scales contains about 10 to about 20 wt. % of a foaming agent, about 25 to about 35 wt. % of an iron sulfide dissolver, and about 3 to about 5 wt. % of a corrosion inhibitor. In some embodiments, the composition for removing FeS scales contains about 15 wt. % of a foaming agent, about 30 wt. % of an iron sulfide dissolver, and about 5 wt. % of a corrosion inhibitor.

In some embodiments, the foaming agent is selected from a nonionic surfactant, an anionic surfactant, a cationic surfactant, an anionic-nonionic surfactant, an amphoteric ion surfactant, or combinations thereof.

In some embodiments, the foaming agent includes a non-ionic surfactant. A non-ionic surfactant has no charged groups in its head. In some embodiments, the non-ionic surfactants include alkanolamides of fatty acids, that is, amide reaction products between a fatty acid and an alkanolamine compound, such as coconut fatty acid monoethanolamide (e.g., N-methyl coco fatty ethanol amide), coconut fatty acid diethanolamide, oleic acid diethanolamide, and vegetable oil fatty acid diethanolamide. In some embodiments, the non-ionic surfactants may include alkoxylated alkanolamides of fatty acids, ethoxylated and/or propoxylated variants of the alkanolamides of fatty acids having anywhere from 2 to 30 EO and/or PO molar equivalents, such as 3 to 15 EO and/or PO molar equivalents, 4 to 10 EO and/or PO molar equivalents, or 5 to 8 EO and/or PO molar equivalents per moles of the alkanolamide of the fatty acid (e.g., coconut fatty acid monoethanolamide with 4 moles of ethylene oxide). In some embodiments, the non-ionic surfactants include amine oxides, such as N-cocoamidopropyl dimethyl amine oxide and dimethyl C₆-C₂₂ alkyl amine oxide (e.g., dimethyl coco amine oxide). In some embodiments, the non-ionic surfactants include fatty esters, such as ethoxylated and/or propoxylated fatty acids (e.g., castor oil with 2 to 40 moles of ethylene oxide), alkoxylated glycerides (e.g., PEG-24 glyceryl monostearate), glycol esters and derivatives, monoglycerides, polyglyceryl esters, esters of polyalcohols, and sorbitan/sorbitol esters. In some embodiments, the non-ionic surfactants include ethers, such as (i) alkoxylated C₁-C₂₂ alkanols, which may include alkoxylated C₁-C₅ alkanols, such as ethoxylated or propoxylated C₁-C₅ alkanols (e.g., dipropylene glycol n-butyl ether, tripropylene glycol n-butyl ether, dipropylene glycol methyl ether, tripropylene glycol methyl ether, diethylene glycol n-butyl ether, triethylene glycol n-butyl ether, diethylene glycol methyl ether, triethylene glycol methyl ether), and alkoxylated C₆-C₂₆ alkanols (e.g., alkoxylated fatty alcohols), alkoxylated C₇-C₂₂ alkanols, alkoxylated C₈-C₁₄ alkanols, ethoxylated or propoxylated (e.g., cetyl stearyl alcohol with 2 to 40 moles of ethylene oxide, lauric alcohol with 2 to 40 moles of ethylene oxide, oleic alcohol with 2 to 40 moles of ethylene oxide, ethoxylated lanoline derivatives, laureth-3, ceteareth-6, ceteareth-11, ceteareth-15, ceteareth-16, ceteareth-17, ceteareth-18, ceteareth-20, ceteareth-23, ceteareth-25, ceteareth-27, ceteareth-28, ceteareth-30, isoceteth-20, and laureth-9/myreth-9, PPG-3 caprylyl ether), (ii) alkoxylated polysiloxanes, (iii) ethylene oxide/propylene oxide copolymers (e.g., PPG-I-PEG-9-lauryl glycol ether, PPG-I2-buteth-I6, PPG-3-buteth-5, PPG-5-buteth-7, PPG-7-buteth-I0, PPG-9-buteth-I2, PPG-I2-buteth-I6, PPG-I5-buteth-20, PPG-20-buteth-30, PPG-28-buteth-35, and PPG-33-buteth-45), and (iv) alkoxylated alkylphenols.

In some embodiments, the foaming agent includes a cationic surfactant. A cationic surfactant carries a positive electrical charge (cation) when dissolved in water or another polar solvent. In some embodiments, the cationic surfactants include, but are not limited to (i) a protonated amine formed from a reaction between a C₆-C₂₆ alkyl amine compound and an acid (e.g., acetic acid, formic acid, propionic acid, butyric acid, pentanoic acid, hexanoic acid, oxalic acid, malonic acid, lactic acid, glyceric acid, glycolic acid, malic acid, citric acid, benzoic acid, p-toluenesulfonic acid, trifluoromethanesulfonic acid, hydrochloric acid, nitric acid, phosphoric acid, sulfuric acid, hydrobromic acid, perchloric acid, and hydroiodic acid), such as protonated salts of C₆-C₂₆ alkyl monoamines, C₆-C₂₆ alkyl (poly)alkylene polyamines, and alkoxylated fatty amines; (ii) a protonated C₆-C₂₆ alkyl amidoamine formed from a reaction between a C₆-C₂₆ alkyl amidoamine compound and an acid (for example the acids listed above), such as protonated forms of the amide reaction product between any fatty acid previously listed (or ester derivative thereof) with a polyamine (e.g., putrescine, cadaverine, ethylene diamine, N,N-dimethylethane-1,2-diamine, N,N-dimethylpropane-1,3-diamine, N,N-diethylethane-1,2-diamine, N,N-diethylpropane-1,3-diamine, spermidine, 1,1,1-tris(aminomethyl) ethane, tris(2-aminoethyl)amine, hexabutylene heptaminetetraethylenepentamine (TEPA), diethylenetriamine (DETA), triethylenetetramine (TETA), aminoethylethanolamine (A EEA), pentaethylenehexamine (PEHA), hexaethyleneheptamine (HEHA), spermine, dipropylene triamine, tripropylene tetramine, tetrapropylene pentamine, pentapropylene hexamine, hexapropylene heptamine, dibutylene triamine, tributylene tetramine, tetrabutylene pentamine, pentabutylene hexamine), with specific mention being made to protonated forms of stearamidopropyldimethylamine, stearamidopropyldiethylamine, stearamidoethyldimethylami ne, stearamidoethyldiethylamine, palmitamidopropyldimethylamine, palmitamidopropyldiethyla mine, palmitamidoethyldiethylamine, palmitamidoethyldimethylamine, behenamidopropyldimet hylamine, behenamidopropyldiethylmine, behenamidoethyldiethylamine, behenamidoethyldimet hylamine, arachidamidopropyldimethylamine, arachidamidopropyldiethylamine, arachidamidoet hyldiethylamine, and arachidamidoethyldimethylamine; and (iii) a quaternary ammonium compound made from alkylation with suitable alkylating agents (e.g., dimethyl sulfate, methyl chloride or bromide, benzyl chloride or bromide, C₆-C₂₆ alkyl chloride or bromide) of a tertiary C₆-C₂₆ alkyl amine, an alkoxylated (tertiary) amine, or an aprotic nitrogenous heteroarene (optionally substituted) having at least one aromatic nitrogen atom with a reactive lone pair of electrons, with specific mention being made to a C₁₀-C₁₈ alkyl trimethylammonium chloride or methosulfate, a di-C₁₀-C₁₈ alkyl dimethyl ammonium chloride or methesulfate, a C₁₀-C₁₈ alkyl benzyl dimethyl ammonium chloride, a methyl quaternized C₆-C₂₂ alkyl propylene diamine, a methyl quaternized C₆-C₂₂ alkyl propylene triamine, a methyl quaternized C₆-C₂₂ alkyl propylene tetraamine, a N—C₁₀-C₁₈ alkyl pyridinium or a quinolinium bromide or chloride such as N-octyl pyridinium bromide, N-nonyl pyridinium bromide, N-decyl pyridinium bromide, N-dodecyl pyridinium bromide, N-tetradecyl pyridinium bromide, Ndodecyl pyridinium chloride, N-cyclohexyl pyridinium bromide, naphthyl methylquinolinium chloride, naphthyl methyl pyridinium chloride, and cetylpyridinium chloride.

In some embodiments, the foaming agent includes an anionic surfactant. An anionic surfactant carries negatively charged (anionic) hydrophilic head groups when dissolved in water. In some embodiments, the anionic surfactants include, but are not limited to (i) sulfates, such as alkyl sulfates, alkyl-ester-sulfates, alkyl-ether-sulfates, alkylalkoxy-ester-sulfates, sulfated alkanolamides, glyceride sulfates, sulfates of fatty alcohols, polyoxyalkylene ethers of fatty alcohols such as sodium dodecyl sulfate, sodium laureth sulfate, ammonium lauryl sulfate, potassium lauryl sulfate, sodium myreth sulfate; (ii) sulfonates such as dodecyl benzene sulfonate, lower alkyl-benzene sulfonates, alpha olefin sulfonates, lignosulfonates, sulfo-carboxylic compounds; (iii) phosphates of fatty alcohols or polyoxyalkylene ethers of fatty alcohols such as cetyl phosphate salts, dicetyl phosphate salts, ceteth-10-phosphate salts; and (iv) carboxylate salts of fatty acids, acylamino acids, lactylates, and/or fatty alcohols/polyoxyalkylene ethers of fatty alcohols such as sodium stearate, sodium behenoyl lactylate, sodium isostearoyl lactylate, sodium caproyl lactylate, sodium laureth-5 carboxylate, sodium laureth-6 carboxylate, sodium laureth-11 carboxylate.

In some embodiments, the foaming agent includes an amphoteric surfactant. An amphoteric surfactant refers to a surfactant compound uniquely structured to function as cationic surfactants at acid pH and anionic surfactants at alkaline pH. In some embodiments, the amphoteric surfactants include, but are not limited to, (i) C₆-C₂₂ alkyl dialkyl betaines, such as fatty dimethyl betaines (R—N(CH₃)₂(+)—CH₂COO—), obtained from a C₆-C₂₂ alkyl dimethyl amine which is reacted with a monohaloacetate salt (e.g., sodium monochloroacetate), such as C₁₂-C₁₄ dimethyl betaine (carboxylate methyl C₁₂-C₁₄ alkyl dimethylammonium); (ii) C₆-C₂₂ alkyl amido betaines (R—CO—NH—CH₂CH₂CH₂—N(CH₃)₂(+)—CH₂COO— or R—CO—NH—CH₂CH₂—N(CH₃)₂(+)—CH₂COO—), obtained by the reaction of a monohaloacetate salt (e.g., sodium monochloroacetate) with the reaction product of either dimethyl amino propylamine or dimethyl amino ethylamine with a suitable carboxylic acid or ester derivatives thereof, such as C₁₀-C₁₈ amidopropyl dimethylamino betaine; and (iii) C₆-C₂₂ alkyl sultaines or C₆-C₂₂ alkyl amido sultaines, which are similar to those C₆-C₂₂ alkyl dialkyl betaines or C₆-C₂₂ alkyl amido betaines described above except in which the carboxylic group has been substituted by a sulfonic group (R—N(CH₃)₂(+)—CH₂CH₂CH₂SO₃— or R—CO—NH—CH₂CH₂CH₂—N(CH₃)₂(+)—CH₂CH₂CH₂SO₃— or R—CO—NH—CH₂CH₂—N(CH₃)₂(+)—CH₂CH₂CH₂SO₃—) or a hydroxy sulfonic group (R—N(CH₃)₂(+)—CH₂CH(OH)—CH₂SO₃— or R—CO—NHCH₂CH₂CH₂—N(CH₃)₂(+)—CH₂CH(OH)—CH₂SO₃— or R—CO—NH—CH₂CH₂—N(CH₃)₂(+)—CH₂CH(OH)—CH₂SO₃—), such as C₁₀-C₁₈ dimethyl hydroxysultaine and C₁₀-C₁₈ amido propyl dimethylamino hydroxysultaine. In some embodiments, the amphoteric surfactant is selected from fatty betaine or fatty sulfobetaine.

In some embodiments, the foaming agent is a fatty betaine or fatty sulfobetaine composition. In some embodiments, the foaming agent is selected from sodium lauryl sulfate, sodium dodecylbenzenesulfonate, cocamidopropyl betaine, cocamidopropyl hydroxyl sulfobetaine, cocamidopropyl hydroxy sultaine, or combinations thereof.

In some embodiments, the iron sulfide dissolver is selected from an acid-based dissolver, a chelating agent, an oxidizing agent, a thiocarbamate compound, or combinations thereof.

In some embodiments, the iron sulfide dissolver includes a chelating agent. In some embodiments, the chelating agent is selected from the group consisting of a polyamino polycarboxylic chelating agent, a quaternary ammonium salt, a quaternary phosphonium salt, and combinations thereof. In some embodiments, the iron sulfide dissolver is a polyamino polycarboxylic chelating agent selected from the group consisting of ethylenediamine tetraacetic acid (EDTA), ethylene glycol tetraacetic acid (EGTA), cyclohexanenediamine tetraacetic acid (CDTA), hydroxyethylenediamine triacetic acid (HEDTA), diethylenetriamine pentaacetic acid (DPTA), dimercaptopropane sulfonic acid (DPMS), glutamic acid diacetic acid (GLDA), dimercaptosuccinic acid (DMSA), ethylene diamine di-ortho-hydroxy-phenyl acetic acid (EDDHA), ethylene diamine di-ortho-hydroxy-para-methyl phenyl acetic acid (EDDHMA), and ethylene diamine di-ortho-hydroxy-para-carboxy-phenyl acetic acid (EDDCHA). In some embodiments, the polyamino polycarboxylic chelating agent includes an EDTA salt selected from the group consisting of diammonium EDTA, disodium DEDTA, dipotassium EDTA, triammonium EDTA, trisodium EDTA, tripotassium EDTA, tetrasodium EDTA, tetrapotassium EDTA, calcium disodium EDTA, and combinations thereof. In some embodiments, the iron sulfide dissolver is a polyamino polycarboxylic chelating agent selected from EDTA, HEDTA, DTPA, GLDA, or THPS (tetrakis hydroxymethyl phosphonium sulfate).

In some embodiments, the iron sulfide dissolver is a quaternary ammonium salt selected from the group consisting of tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium salts, monomethyl dialkyl benzyl quaternary ammonium salts, trimethyl benzyl quaternary ammonium salts, trialkyl benzyl quaternary ammonium salts, and combinations thereof. Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt. In some embodiments, the quaternary ammonium salt includes a benzyl trialkyl quaternary ammonium salt, a benzyl triethanolamine quaternary ammonium salt, or a benzyl dimethylaminoethanolamine quaternary ammonium salt.

In some embodiments, the iron sulfide dissolver is a quaternary phosphonium salt. In some embodiments, the quaternary phosphonium salt is selected from the group consisting of an alkyltris(hydroxyorgano)phosphonium salt, an alkenyltris(hydroxyorgano) phosphonium salt, a tetrakis(hydroxyorgano) phosphonium salt, and combinations thereof. In some embodiments, the quaternary phosphonium salt is a tetrakis(hydroxyorgano) phosphonium salt. In some embodiments, the tetrakis(hydroxyorgano) phosphonium salt is selected from the group consisting of tetrakis(hydroxymethyl)phosphonium sulfate (THPS), tetrakis(hydroxymethyl)phosphonium chloride, tetrakis(hydroxymethyl)phosphonium bromide, tetrakis(hydroxymethyl)phosphonium acetate, and tetrakis(hydroxymethyl)phosphonium phosphate. In some embodiments, the quaternary phosphonium salt includes tetrakis(hydroxymethyl)-phosphonium sulfate (THPS).

In some embodiments, the iron sulfide dissolver includes an acid-based dissolver selected from the group consisting of allaric acid, altaric acid, altraric acid, altronic acid, arabinaric acid, arabinonic acid, dihomocitric acid, fructuronic acid, fuconic acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, or xyluronic acid, or a salt or derivative thereof, or a combination thereof. In some embodiments, the acid-based dissolver is selected from the group consisting of gluconic acid, glucaric acid, a salt or derivative thereof, and combinations thereof. In some embodiments, the acid-based dissolver is selected from the group consisting of sodium gluconate, ammonium gluconate, potassium gluconate, lithium gluconate, magnesium gluconate, calcium gluconate, cesium gluconate, gluconic acid, sodium glucarate, ammonium glucarate, potassium glucarate, lithium glucarate, magnesium glucarate, calcium glucarate, cesium glucarate, glucaric acid, and combinations thereof.

In some embodiments, the iron sulfide dissolver includes an oxidizing agent selected from the group consisting of hydrogen peroxide (H₂O₂), sodium hypochlorite (NaClO), peracetic acid, and combinations thereof. In some embodiments, the oxidizing agent includes hydrogen peroxide (H₂O₂) and peracetic acid.

In some embodiments, the iron sulfide dissolver includes a thiocarbamate compound selected from the group consisting of dithiocarbamate compounds, bis-dithiocarbamate compounds, and combinations thereof. In some embodiments, the iron sulfide dissolver includes a dithiocarbamate compound of Formula (I).

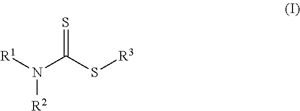

In some embodiments, R 1 and R² are each independently selected from H, D, C₁-C₁₄ alkyl, C₂-C₆ alkenyl, C₂-C₆ alkynyl, C₁-C₁₄ haloalkyl, C₆-C₁₀ aryl, C₃-C₁₄ cycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R¹ and R² are each independently selected from H, D, C₁-C₁₄ alkyl, C₁-C₁₄ haloalkyl, C₆-C₁₀ aryl, C₃-C₁₄ cycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R 1 and R² are each independently selected from H, D, C₁-C₁₄ alkyl, C₆-C₁₀ aryl, and C₆-C₁₀ aryl-C₁-C₄ alkyl-. In some embodiments, R¹ and R² are each independently selected from C₁-C₁₄ alkyl, C₆-C₁₀ aryl, and C₆-C₁₀ aryl-C₁-C₄ alkyl-. In some embodiments, R¹ and R² are each independently selected from methyl, ethyl, propyl, butyl, phenyl, and benzyl. In some embodiments, R³ is selected from H, D, C₁-C₁₄ alkyl, C₂-C₆ alkenyl, C₂-C₆ alkynyl, C₁-C₁₄ haloalkyl, C₆-C₁₀ aryl, C₃-C₁₄ cycloalkyl, 5-14 membered heteroaryl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R³ is selected from H, D, C₁-C₁₄ alkyl, C₁-C₁₄ haloalkyl, C₆-C₁₀ aryl, C₃-C₁₄ cycloalkyl, 5-14 membered heteroaryl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R³ is selected from H, D, C₁-C₁₄ alkyl, C₁-C₁₄ haloalkyl, C₆-C₁₀ aryl, C₃-C₁₄ cycloalkyl, 5-14 membered heteroaryl, 4-14 membered heterocycloalkyl, and C₆-C₁₀ aryl-C₁-C₄ alkyl-. Suitable dithiocarbamate compound include, but are not limited to dimethyldithiocarbamate, diethyldithiocarbamate, dibutyldithiocarbamate, dibenzyldithiocarbamate, piperidinepentamethylenedithiocarbamate and ethylphenyldithiocarbamate.

In some embodiments, the corrosion inhibitor is selected from the group consisting of a fatty amine, a fatty diamine, a fatty acid, an imidazoline, a phosphate ester, an amide, a thioamide, a thiol, a thioalcohol, and combinations thereof. In some embodiments, the corrosion inhibitor is an organic compound that contains unsaturated bonds or atoms, such as N, O, or S, for example, long chain primary amines, imidazolines, fatty acids and phosphate esters.

In some embodiments, the corrosion inhibitor includes a fatty amine selected from the group consisting of n-octylamine, n-decylamine, n-dodecylamine, n-tetradecylamine, n-hexadecylamine, n-octadecylamine, stearylamine, oleyamine, tallowamine, cocoamine, and soyaamine. In some embodiments, the fatty amine is selected from the group consisting of n-octylamine, n-decylamine, n-dodecylamine, and tallowamine.

In some embodiments, the corrosion inhibitor includes a fatty diamine selected from the group consisting of N-octyl diaminoalkane, N-decyl diaminoalkane, N-dodecyl diaminoalkane, N-tetradecyl diaminoalkane, N-hexadecyl diaminoalkane, N-octadecyl diaminoalkane, N-stearyl diaminoalkane, N-oleyl diaminoalkane, N-tallow diaminoalkane, N-cocoyl diaminoalkane, and N-soya diaminoalkane. In some embodiments, the fatty diamine is selected from the group consisting of N-octyl diaminoalkane, N-decyl diaminoalkane, N-dodecyl diaminoalkane, and N-tallow diaminoalkane.

In some embodiments, the corrosion inhibitor includes a fatty acid selected from the group consisting of caprylic acid, pelargonic acid, capric acid, undecylenic acid, lauric acid, tridecylic acid, myristic acid, pentadecylic acid, palmitic acid, heptadecanoic acid, stearic acid, nonadecylic acid, arachidic acid, heneicosylic acid, behenic acid, tricosylic acid, lignoceric acid, pentacosylic acid, cerotic acid, heptacosylic acid, myristoleic acid, palmitoleic acid, sapienic acid, oleic acid, elaidic acid, vaccenic acid, linoleic acid, linoelaidic acid, α-linolenic acid, γ-linolenic acid, arachidonic acid, eicosapentaenoic acid, erucic acid, docosahexaenoic acid, cis-11-octadecenoic acid, cis-11-eicosenoic acid, cis-13-docosenoic acid, neoheptanoic acid, neononanoic acid, neodecanoic acid, isostearic acid, and 10-undecenoic acid. In some embodiments, the fatty acid is selected from the group consisting of caprylic acid, heptadecanoic acid, stearic acid, oleic acid, linoleic acid, and linoelaidic acid.

In some embodiments, the corrosion inhibitor includes an imidazoline of Formula (II).

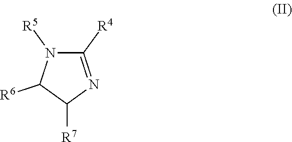

In some embodiments, R⁴ is selected from the group consisting of H, D, C₁-C₂₀ alkyl, C₂-C₆ alkenyl, C₂-C₆ alkynyl, C₁-C₂₀ haloalkyl, C₁-C₂₀ alkoxyalkyl, C₆-C₁₀ aryl, C₃-C₁₄ cycloalkyl, 5-14 membered heteroaryl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R⁴ is selected from the group consisting of H, D, C₁-C₂₀ alkyl, C₂-C₆ alkenyl, C₂-C₆ alkynyl, C₁-C₂₀ haloalkyl, and C₁-C₂₀ alkoxyalkyl. In some embodiments, R⁴ is selected from the group consisting of H, C₁-C₂₀ alkyl, C₁-C₂₀ haloalkyl, and C₁-C₂₀ alkoxyalkyl. In some embodiments, R 4 is selected from the group consisting of C₁-C₁₄ alkyl and C₁-C₁₄ alkoxyalkyl. In some embodiments, R⁴ is C₁-C₁₄ alkyl. In some embodiments, R⁴ is C₁-C₁₄ alkoxyalkyl.

In some embodiments, R⁵ is selected from the group consisting of H, D, C₁-C₂₀ alkyl, C₁-C₂₀ haloalkyl, C₁-C₂₀ alkoxyalkyl, C₁-C₂₀ hydroxyalkyl, C₆-C₁₀ aryl, C₃-C₁₄ cycloalkyl, 5-14 membered heteroaryl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R⁵ is selected from the group consisting of H, D, C₁-C₂₀ alkyl, C₁-C₂₀ haloalkyl, C₁-C₂₀ alkoxyalkyl, C₁-C₂₀ hydroxyalkyl, C₆-C₁₀ aryl, 5-14 membered heteroaryl, C₆-C₁₀ aryl-C₁-C₄ alkyl-, and (5-14 membered heteroaryl)-C₁-C₄ alkyl-. In some embodiments, R⁵ is selected from the group consisting of H, C₁-C₂₀ alkyl, C₁-C₂₀ alkoxyalkyl, C₁-C₂₀ hydroxyalkyl, and C₆-C₁₀ aryl-C₁-C₄ alkyl-. In some embodiments, R⁵ is selected from the group consisting of H, C₁-C₁₄ alkyl, C₁-C₁₄ alkoxyalkyl, C₁-C₁₄ hydroxyalkyl, and C₆-C₁₀ aryl-C₁-C₄ alkyl-. In some embodiments, R⁵ is C₁-C₁₄ alkyl. In some embodiments, R⁵ is C₁-C₁₄ alkoxyalkyl. In some embodiments, R⁵ is C₁-C₁₄ hydroxyalkyl. In some embodiments, R⁵ is C₆-C₁₀ aryl-C₁-C₄ alkyl-.

In some embodiments, R⁶ and R 7 are each independently selected from the group consisting of H, D, C₁-C₂₀ alkyl, C₂-C₆ alkenyl, C₂-C₆ alkynyl, C₁-C₂₀ haloalkyl, C₁-C₂₀ alkoxyalkyl, C₃-C₁₄ cycloalkyl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R⁶ and R⁷ are each independently selected from the group consisting of H, D, C₁-C₂₀ alkyl, C₁-C₂₀ haloalkyl, C₁-C₂₀ alkoxyalkyl. In some embodiments, R⁶ and R⁷ are each independently selected from the group consisting of H, D, and C₁-C₂₀ alkyl. In some embodiments, R⁶ and R⁷ are each independently selected from the group consisting of H and C₁-C₁₄ alkyl. In some embodiments, R⁶ and R⁷ are each independently selected from the group consisting of H and C₁-C₁₄ alkyl. In some embodiments, R 6 and R 7 are each independently selected from the group consisting of H and C₁-C₆ alkyl.

In some embodiments, R⁶ and R⁷, taken together with the atoms to which they are attached form a 3-, 4-, 5-, or 6-membered heterocycloalkyl or a 3-, 4-, 5-, or 6-membered cycloalkyl, wherein the 3-6 membered heterocycloalkyl or 3-6 membered cycloalkyl is optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, C₁₋₆ haloalkoxy, C₂₋₆ alkenyl, C₂₋₆ alkynyl, C₆₋₁₀ aryl, C₃₋₁₄ cycloalkyl, 5-14 membered heteroaryl, 4-14 membered heterocycloalkyl, C₆₋₁₀ aryl-C₁₋₄ alkyl-, C₃₋₁₄ cycloalkyl-C₁₋₄ alkyl-, (5-14 membered heteroaryl)-C₁₋₄ alkyl-, and (4-14 membered heterocycloalkyl)-C₁₋₄ alkyl-. In some embodiments, R⁶ and R⁷, taken together with the atoms to which they are attached form a 3-, 4-, 5-, or 6-membered heterocycloalkyl optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, and C₁₋₆ haloalkoxy. In some embodiments, R⁶ and R⁷, taken together with the atoms to which they are attached form a 3-, 4-, 5-, or 6-membered cycloalkyl optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, and C₁₋₆ haloalkoxy.

In some embodiments, the corrosion inhibitor includes a phosphate ester selected from the group consisting of alkyl phosphate esters, alkylaryl phosphate esters, and arylalkyl phosphate esters. In some embodiments, the phosphate ester includes alkyl phosphate esters, such as a C₆-C₂₀ phosphate ester, a C₈-C₁₈ phosphate ester, a C₁₀-C₁₆ phosphate ester, or a C₁₂-C₁₄ phosphate ester. In some embodiments, the phosphate ester includes C₁₈ alkenyl esters, such as oleyl alcohol phosphate ester, 3-phosphate oleyl ether, or oleyl ether-10-phosphate.

In some embodiments, the corrosion inhibitor composition includes an amide. The amide can be a primary, secondary, or tertiary amide. The amide is a compound of Formula (III).

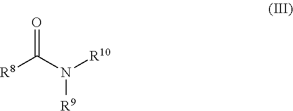

In some embodiments, R⁸ is selected from the group consisting of H, D, C₁-C₂₀ alkyl, C₁-C₂₀ haloalkyl, C₁-C₂₀ alkoxyalkyl, C₁-C₂₀ hydroxyalkyl, C₆-C₁₀ aryl, C₃-C₁₄ cycloalkyl, 5-14 membered heteroaryl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R⁸ is selected from the group consisting of H, D, C₁-C₂₀ alkyl, C₁-C₂₀ haloalkyl, C₁-C₂₀ alkoxyalkyl, C₁-C₂₀ hydroxyalkyl, C₆-C₁₀ aryl, 5-14 membered heteroaryl, C₆-C₁₀ aryl-C₁-C₄ alkyl-, and (5-14 membered heteroaryl)-C₁-C₄ alkyl-. In some embodiments, R⁵ is selected from the group consisting of H, C₁-C₂₀ alkyl, C₁-C₂₀ alkoxyalkyl, C₁-C₂₀ hydroxyalkyl, and C₆-C₁₀ aryl-C₁-C₄ alkyl-. In some embodiments, R⁸ is selected from the group consisting of H, C₁-C₁₄ alkyl, C₁-C₁₄ alkoxyalkyl, C₁-C₁₄ hydroxyalkyl, and C₆-C₁₀ aryl-C₁-C₄ alkyl-. In some embodiments, R⁵ is C₁-C₁₄ alkyl. In some embodiments, R⁸ is C₁-C₁₄ alkoxyalkyl. In some embodiments, R⁵ is C₁-C₁₄ hydroxyalkyl. In some embodiments, R⁵ is C₆-C₁₀ aryl-C₁-C₄ alkyl-.

In some embodiments, R⁹ and R¹⁰ are each independently selected from the group consisting of H, D, C₁-C₂₀ alkyl, C₂-C₆ alkenyl, C₂-C₆ alkynyl, C₁-C₂₀ haloalkyl, C₁-C₂₀ alkoxyalkyl, C₃-C₁₄ cycloalkyl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R⁹ and R¹⁰ are each independently selected from the group consisting of H, D, C₁-C₂₀ alkyl, C₁-C₂₀ haloalkyl, C₁-C₂₀ alkoxyalkyl. In some embodiments, R⁹ and R¹⁰ are each independently selected from the group consisting of H, D, and C₁-C₂₀ alkyl. In some embodiments, R⁹ and R¹⁰ are each independently selected from the group consisting of H and C₁-C₁₄ alkyl. In some embodiments, R⁹ and R¹⁰ are each independently selected from the group consisting of H and C₁-C₁₄ alkyl. In some embodiments, R⁹ and R¹⁰ are each independently selected from the group consisting of H and C₁-C₆ alkyl.

In some embodiments, R 9 and R 10, taken together with the atoms to which they are attached form a 3-, 4-, 5-, or 6-membered heterocycloalkyl or a 3-, 4-, 5-, or 6-membered cycloalkyl, wherein the 3-6 membered heterocycloalkyl or 3-6 membered cycloalkyl is optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, C₁₋₆ haloalkoxy, C₂₋₆ alkenyl, C₂₋₆ alkynyl, C₆₋₁₀ aryl, C₃₋₁₄ cycloalkyl, 5-14 membered heteroaryl, 4-14 membered heterocycloalkyl, C₆₋₁₀ aryl-C₁₋₄ alkyl-, C₃₋₁₄ cycloalkyl-C₁₋₄ alkyl-, (5-14 membered heteroaryl)-C₁₋₄ alkyl-, and (4-14 membered heterocycloalkyl)-C₁₋₄ alkyl-. In some embodiments, R 9 and R 10, taken together with the atoms to which they are attached form a 3-, 4-, 5-, or 6-membered heterocycloalkyl optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, and C₁₋₆ haloalkoxy. In some embodiments, R⁹ and R 10, taken together with the atoms to which they are attached form a 3-, 4-, 5-, or 6-membered cycloalkyl optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, and C₁₋₆ haloalkoxy.

In some embodiments, the corrosion inhibitor composition includes a thioamide of Formula (IV). In some embodiments, the thioamide has 2 to 20 carbon atoms, such as 2-18 carbon atoms, 4-16 carbon atoms, 6-14 carbon atoms, 8-12 carbon atoms, or about 10 carbon atoms.

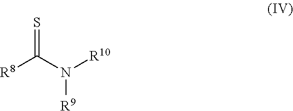

In some embodiments, R⁸ is selected from the group consisting of H, D, C₁-C₂₀ alkyl, C₁-C₂₀ haloalkyl, C₁-C₂₀ alkoxyalkyl, C₁-C₂₀ hydroxyalkyl, C₆-C₁₀ aryl, C₃-C₁₄ cycloalkyl, 5-14 membered heteroaryl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R 8 is selected from the group consisting of H, D, C₁-C₂₀ alkyl, C₁-C₂₀ haloalkyl, C₁-C₂₀ alkoxyalkyl, C₁-C₂₀ hydroxyalkyl, C₆-C₁₀ aryl, 5-14 membered heteroaryl, C₆-C₁₀ aryl-C₁-C₄ alkyl-, and (5-14 membered heteroaryl)-C₁-C₄ alkyl-. In some embodiments, R⁵ is selected from the group consisting of H, C₁-C₂₀ alkyl, C₁-C₂₀ alkoxyalkyl, C₁-C₂₀ hydroxyalkyl, and C₆-C₁₀ aryl-C₁-C₄ alkyl-. In some embodiments, R⁸ is selected from the group consisting of H, C₁-C₁₄ alkyl, C₁-C₁₄ alkoxyalkyl, C₁-C₁₄ hydroxyalkyl, and C₆-C₁₀ aryl-C₁-C₄ alkyl-. In some embodiments, R⁵ is C₁-C₁₄ alkyl. In some embodiments, R⁸ is C₁-C₁₄ alkoxyalkyl. In some embodiments, R⁵ is C₁-C₁₄ hydroxyalkyl. In some embodiments, R⁵ is C₆-C₁₀ aryl-C₁-C₄ alkyl-.

In some embodiments, R⁹ and R¹⁰ are each independently selected from the group consisting of H, D, C₁-C₂₀ alkyl, C₂-C₆ alkenyl, C₂-C₆ alkynyl, C₁-C₂₀ haloalkyl, C₁-C₂₀ alkoxyalkyl, C₃-C₁₄ cycloalkyl, 4-14 membered heterocycloalkyl, C₆-C₁₀ aryl-C₁-C₄ alkyl-, C₃-C₁₄ cycloalkyl-C₁-C₄ alkyl-, (5-14 membered heteroaryl)-C₁-C₄ alkyl-, and (4-14 membered heterocycloalkyl)-C₁-C₄ alkyl-. In some embodiments, R 9 and R¹⁰ are each independently selected from the group consisting of H, D, C₁-C₂₀ alkyl, C₁-C₂₀ haloalkyl, C₁-C₂₀ alkoxyalkyl. In some embodiments, R⁹ and R¹⁰ are each independently selected from the group consisting of H, D, and C₁-C₂₀ alkyl. In some embodiments, R⁹ and R¹⁰ are each independently selected from the group consisting of H and C₁-C₁₄ alkyl. In some embodiments, R⁹ and R¹⁰ are each independently selected from the group consisting of H and C₁-C₁₄ alkyl. In some embodiments, R⁹ and R¹⁰ are each independently selected from the group consisting of H and C₁-C₆ alkyl.

In some embodiments, R 9 and R 10, taken together with the atoms to which they are attached form a 3-, 4-, 5-, or 6-membered heterocycloalkyl or a 3-, 4-, 5-, or 6-membered cycloalkyl, wherein the 3-6 membered heterocycloalkyl or 3-6 membered cycloalkyl is optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, C₁₋₆ haloalkoxy, C₂₋₆ alkenyl, C₂₋₆ alkynyl, C₆₋₁₀ aryl, C₃₋₁₄ cycloalkyl, 5-14 membered heteroaryl, 4-14 membered heterocycloalkyl, C₆₋₁₀ aryl-C₁₋₄ alkyl-, C₃₋₁₄ cycloalkyl-C₁₋₄ alkyl-, (5-14 membered heteroaryl)-C₁₋₄ alkyl-, and (4-14 membered heterocycloalkyl)-C₁₋₄ alkyl-. In some embodiments, R 9 and R 10, taken together with the atoms to which they are attached form a 3-, 4-, 5-, or 6-membered heterocycloalkyl optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, and C₁₋₆ haloalkoxy. In some embodiments, R 9 and R 10, taken together with the atoms to which they are attached form a 3-, 4-, 5-, or 6-membered cycloalkyl optionally substituted with 1, 2, 3, or 4 substituents selected from the group consisting of H, D, halo, CN, OH, oxo, NH₂, NHC₁₋₆ alkyl, N(C₁₋₆ alkyl)₂, NO₂, C₁₋₆ alkyl, C₁₋₆ haloalkyl, C₁₋₆ alkoxy, and C₁₋₆ haloalkoxy.

In some embodiments, the thioamide is selected from the group consisting of thiobenzamide, 4-(trifluoromethoxyl)thiobenzamide, 4-(acetoxymethyl) thiobenzamide, 3,4-dimethyl thiobenzamide, 3-(acetoxymethyl) thiobenzamide, 4-(methylthio) thiobenzamide, 4-(acetoxy) thiobenzamide, 3-(acetoxy) thiobenzamide, 4-(2-methyl-4-thiazolyl) thiobenzamide. In some embodiments, the thioamide is thiobenzamide of Formula (V).

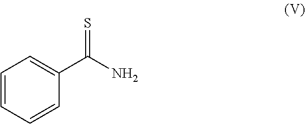

In some embodiments, the corrosion inhibitor composition includes a thiol or a thioalcohol. In some embodiments, the thioalcohol has 2-20 carbon atoms, such as 4-18 carbon atoms, 6-16 carbon atoms, 8-14 carbon atoms, 10-12 carbon atoms, or 10 carbon atoms. In some embodiments, the thioalcohol is at least one selected from the group consisting of 2-mercaptoethanol, 3-mercapto-1-propanol, 8-mercapto-1-octanol, 6-mercapto-1-hexanol, 9-mercapto-1-nonanol. In a preferred embodiment, the thioalcohol is 2-mercaptoethanol.

In some embodiments, the corrosion inhibitor composition further includes a solvent selected from an alcohol, a hydrocarbon, a ketone, an ether, an alkylene glycol, a glycol ether, an amide, a nitrile, a sulfoxide, an ester, a polyol, or combinations thereof. As used herein, a solvent refers is optionally added into the corrosion inhibitor composition primarily for the purposes of enhancing the water solubility or oil solubility of the corrosion inhibitor. In some embodiments, the solvent does not participate in chemical reactions which prevent corrosion. The solvent may be polar, nonpolar, or a combination thereof. In an embodiment, the solvent is a polar solvent, such as water, acetone, acetonitrile, dimethylformamide (DMF), dimethyl sulfoxide (DMSO), isopropanol, methanol, or a combination thereof. In another embodiment, a non-polar solvent such as alkanes (pentane, hexane, and heptane) or aromatic solvents (benzene, toluene, and xylene) can be used as the solvent. In one embodiment, the solvent is polar, and the preferred polar solvent is water. Using a polar solvent such as water overcomes the drawbacks, such as toxicity, associated with conventionally used organic solvents in corrosion inhibitor compositions. Examples of solvents include, but are not limited to, water, glycerins, glycols (e.g., polyglycols, propylene glycol, and ethylene glycol), polyglycol amines, polyols, any derivative thereof, and any combination thereof.

In some embodiments, the corrosion inhibitor composition further includes an alcohol selected from an aliphatic alcohol or aromatic alcohol. In an embodiment, the alcohol is an aromatic alcohol. Suitable examples of the aromatic alcohols include, but are not limited to, tryptophol, tyrosol, phenethyl alcohol (phenyl ethanol), benzyl alcohol, etcetera. In another embodiment, the alcohol is an aliphatic alcohol. The aliphatic alcohols may have 1 to 8 carbon atoms, such as 2-5 carbon atoms, or 2-3 carbon atoms. Suitable examples of the aliphatic alcohols include, but are not limited to, ethanol, methanol, propanol, isopropyl alcohol, butanol, isobutanol, or a combination thereof. In an embodiment, the composition may use a combination of the aliphatic alcohol and an aromatic alcohol. In one embodiment, the aliphatic alcohol is methanol.

In some embodiments, the solvent is present in the corrosion inhibitor composition in an amount of about 30-80 wt. %, such as about 40-70 wt. %, about 50-60 wt. %, or about 60 wt. %, based on a total weight of the corrosion inhibitor composition.

In some embodiments, the composition is capable of reducing a bulk density and hydrostatic pressure of a fluid in a low-pressure gas well. In some embodiments, the composition can reduce the bulk density of the fluid in the low-pressure gas well by at least about 20% based on an initial bulk density of the fluid, such as at least about 30%, at least about 40%, at least about 50%, at least about 60%, at least about 70%, or at least about 80% based on the initial bulk density of the fluid. In some embodiments, the composition can reduce the bulk density of the fluid in the low-pressure gas well by at least 15% based on the initial bulk density of the fluid.

In some embodiments, the composition can reduce the hydrostatic pressure of the fluid in the low-pressure gas well by at least about 20% based on an initial bulk density of the fluid, such as at least about 30%, at least about 40%, at least about 50%, at least about 60%, at least about 70%, or at least about 80% based on the initial hydrostatic pressure of the fluid. In some embodiments, the composition can reduce the hydrostatic pressure of the fluid in the low-pressure gas well by at least 50% based on the initial bulk density of the fluid.

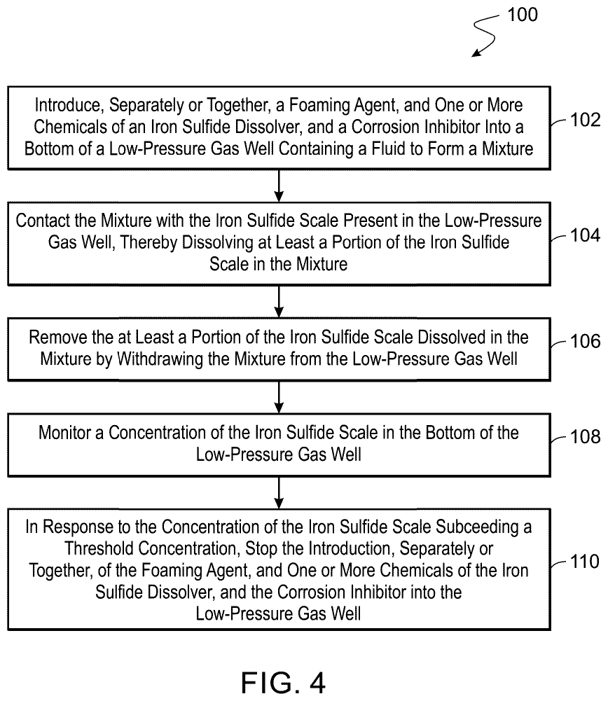

Also provided in the present disclosure is a method of removing an iron sulfide scale. As described in more detail below, FIG. 4 shows a schematic flow chart of a method 100 of removing an iron sulfide scale from a low-pressure gas well. The order in which the method 100 is described is not intended to be construed as a limitation, and any number of the described method steps may be combined in any appropriate order to implement the method 100. Additionally, individual steps may be removed or skipped from the method 100, as appropriate, without departing from the spirit and scope of the present disclosure. Further, additional steps may be added to the method 100 as appropriate.

At step 102, the method 100 includes introducing, separately or together, one or more chemicals selected from the group consisting of a foaming agent, an iron sulfide dissolver, and a corrosion inhibitor into a bottom of a low-pressure gas well comprising a fluid to form a mixture.

In some embodiments, the low-pressure well is selected from a vertical well, a multilateral well, or a horizontal well. In some embodiments, the low-pressure well is located in a subterranean formation selected from the group consisting of an oil shale formation, a tar sands formation, a coal formation, and a conventional hydrocarbon formation.

In some embodiments, the low-pressure gas well has a bottom pressure of less than about 1000 pounds per square inch (psi), such as less than about 900 psi, less than about 800 psi, less than about 700 psi, less than about 600 psi, less than about 500 psi, less than about 400 psi, less than about 300 psi, less than about 200 psi, less than about 100 psi, or less than about 50 psi. In some embodiments, the low-pressure well has a bottom pressure of no more than about 25 psi, such as no more than 75 psi, no more than 125 psi, no more than 175 psi, no more than 225 psi, no more than 275 psi, no more than 325 psi, no more than 375 psi, no more than 425 psi, no more than 475 psi, no more than 525 psi, no more than 575 psi, no more than 625 psi, no more than 675 psi, no more than 725 psi, or no more than 825 psi.

In some embodiments, the bottom of low-pressure gas well is at a depth of about 5000 to about 20000 feet (ft), such as about 7000 to about 17000 ft, about 9000 to 14000 ft, or about 11000 to about 12000 ft.

A foaming agent, an iron sulfide dissolver, and a corrosion inhibitor, and any optional additives may be added using any addition/dosing/mixing techniques known by those of ordinary skill in the art, including both manual and automatic addition techniques. For example, the addition may be carried out by using inline static mixers, inline mixers with velocity gradient control, inline mechanical mixers with variable speed impellers, inline jet mixers, motorized mixers, batch equipment, and appropriate chemical injection pumps and/or metering systems.

In some embodiments, the introducing is performed by pumping, separately or together, the foaming agent, the iron sulfide dissolver, and the corrosion inhibitor, at a wellhead of the low-pressure gas well or by displacing the fluid at the bottom of the low-pressure gas well, separately or together, with the foaming agent, the iron sulfide dissolver, and the corrosion inhibitor via a coiled tubing.

In some embodiments, a composition comprising a foaming agent, an iron sulfide dissolver, and a corrosion inhibitor is first formed in a mixing tank outside the low-pressure gas well. The composition can be formed by mixing a foaming agent, an iron sulfide dissolver, and a corrosion inhibitor. In any of the above applications, the composition may be injected down the annulus of the low-pressure gas well. The method may be performed by injecting the composition into a first wellbore (e.g. an injection wellbore) connected to an inlet of the low-pressure gas well and then collecting hydrocarbons from a second wellbore (e.g. a production wellbore) that is connected to an outlet of the low-pressure gas well. Alternatively, the method may be performed by injecting the composition into a wellbore connected to the low-pressure gas well and then collecting hydrocarbons from the same wellbore. The injection may proceed through suitable injection lines to areas where additional oil recovery (i.e., after primary recovery) is desired through capillaries or umbilical lines. The injection may be performed manually, or it may be automatic, for example, by using chemical injection pumps. In some embodiments, the composition may be stored in a chemical storage tank, and a chemical injection pump associated therewith may be used to introduce the composition into the desired location of the operation, e.g., a bottom of the low-pressure gas well. In any of the above applications, the composition or any of its components combinable downhole may be injected continuously and/or in batches. The chemical injection pump(s) can be automatically or manually controlled to inject any amount of the composition needed for secondary and/or tertiary oil recovery operations.

In some embodiments, the fluid in the low-pressure gas well before includes liquid hydrocarbons, gaseous hydrocarbons, non-hydrocarbon gases, and water. In some embodiments, the liquid hydrocarbons include a crude oil. The crude oil may be a very light crude oil such as Arab Extra Light, Arab Super Light, or Arab Super Light Ardjuna crude oil (e.g., a jet fuel, gasoline, kerosene, petroleum ether, petroleum spirit, or petroleum naphtha crude oil), a light crude oil such as Arab Light or Arab Light/Seg 17 Blend crude oil (e.g., grade 1 and grade 2 fuel oil, diesel fuel oil, domestic fuel oil), a medium crude oil such as A rab Medium crude oil, and a heavy crude oil such as A rab Heavy crude oil (e.g., grade 3, 4, 5, and 6 fuel oil, heavy marine fuel). Both sweet (sulfur volume lower than 0.50%) and sour (sulfur volume higher than 0.50%) crude oils may be displaced and recovered/collected according to the methods herein. In some embodiments, the gaseous hydrocarbons include C₁-C₄ gaseous hydrocarbons and light gas olefins. In some embodiments, the non-hydrocarbon gases include, but are not limited to, carbon dioxide (CO₂), hydrogen sulfide (H₂S), and mercaptans. In some embodiments, the water includes ground water, distilled water, deionized water, saltwater, hard water, fresh water, and wastewater, seawater, brine, saturated brine, or a formate brine.

At step 104, the method 100 includes contacting the mixture with the iron sulfide scale present in the low-pressure gas well, thereby dissolving at least a portion of the iron sulfide scale in the mixture; and

In some embodiments, the iron sulfide scale present in the low-pressure gas well incudes at least one of pyrite, pyrrhotite, troilite, greigite, mackinawite, marcasite, or combinations thereof.

In some embodiments, the iron sulfide scale includes about 0.1 to about 85 wt. % of pyrrhotite, such as about 1 to about 80 wt. %, about 5 to about 75 wt. %, about 10 to about 70 wt. %, about 15 to about 65 wt. %, about 20 to about 60 wt. %, about 25 to about 55 wt. %, about 30 to about 50 wt. %, about 35 to about 45 wt. %, or about 40 wt. % of pyrrhotite based on a total weight of the iron sulfide scale present in the low-pressure gas well.

In some embodiments, the iron sulfide scale includes about 5 to about 70 wt. % of pyrite, such as about 10 to about 65 wt. %, about 15 to about 60 wt. %, about 20 to about 55 wt. %, about 25 to about 50 wt. %, about 30 to about 45 wt. %, or about 35 to about 40 wt. % of pyrite based on a total weight of the iron sulfide scale present in the low-pressure gas well.

In some embodiments, the iron sulfide scale includes about 0.1 to about 10 wt. % of troilite, such as about 1 to 8 wt. %, about 2 to 6 wt. %, or about 3 to 4 wt. % of troilite based on a total weight of the iron sulfide scale present in the low-pressure gas well.

In some embodiments, the iron sulfide scale includes about 0.5 to about 30 wt. % of marcasite, such as about 1 to about 25 wt. %, about 5 to about 20 wt. %, or about 10 to about 15 wt. % of marcasite based on a total weight of the iron sulfide scale present in the low-pressure gas well.

In some embodiments, the iron sulfide scale includes about 0.1 to about 10 wt. % of greigite, such as about 1 to 8 wt. %, about 2 to 6 wt. %, or about 3 to 4 wt. % of greigite based on a total weight of the iron sulfide scale present in the low-pressure gas well.

In some embodiments, the iron sulfide scale includes about 0.01 to about 5 wt. % of mackinawite, such as about 0.5 to about 4 wt. %, about 1 to about 3 wt. %, or about 2 wt. % of mackinawite based on a total weight of the iron sulfide scale present in the low-pressure gas well.

In some embodiments, the iron sulfide scale includes about 0.1 to about 85 wt. % of pyrrhotite; about 5 to about 70 wt. % of pyrite; about 0.1 to about 10 wt. % of troilite; about 0.5 to about 30 wt. % of marcasite; about 0.1 to about 10 wt. % of greigite; and about 0.01 to about 5 wt. % of mackinawite, each wt. % based on a total weight of the iron sulfide scale present in the low-pressure gas well. In some embodiments, the iron sulfide scale includes about 30 to about 70 wt. % of pyrrhotite; about 20 to about 40 wt. % of pyrite; about 1 to about 8 wt. % of troilite; about 1 to about 10 wt. % of marcasite; about 1 to about 8 wt. % of greigite; and about 1 to about 5 wt. % of mackinawite, each wt. % based on a total weight of the iron sulfide scale present in the low-pressure gas well.

In some embodiments, the iron sulfide scale includes about 5 to about 70 wt. % of pyrite, such as about 10 to about 65 wt. %, about 15 to about 60 wt. %, about 20 to about 55 wt. %, about 25 to about 50 wt. %, about 30 to about 45 wt. %, or about 35 to about 40 wt. % of pyrite; and about 0.5 to about 30 wt. % of marcasite, such as about 1 to about 25 wt. %, about 5 to about 20 wt. %, or about 10 to about 15 wt. % of marcasite, each wt. % based on a total weight of the iron sulfide scale present in the low-pressure gas well.

In some embodiments, the low-pressure gas well further includes one or more minerals selected from ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, olivine (fayalite), augite, hedenbergite, biotite, hornblende, garnet (almandine), vivianite, jarosite, glauconite, iron chlorite, native iron, and calcite.

At step 106, the method 100 includes removing the at least a portion of the iron sulfide scale dissolved in the mixture by withdrawing the mixture from the low-pressure gas well.

After the introducing and contacting, the mixture, containing hydrocarbons (e.g., crude oil), FeS, the foaming agent, the iron sulfide dissolver, and the corrosion inhibitor, is brought to the surface may then be separated using techniques known to those of ordinary skill in the art into respective aqueous and oil further processing (e.g., crude oil refining/upgrading/processing). For example, the oil may be separated at a fluids processing facility using emulsion breakers, water clarifiers, and/or other oil/water separation techniques known to those of ordinary skill in the art, such as by using gravity oil separators (API separators), plate separators or coalescing plate separators, separatory funnels, settling tanks, centrifugal separation (e.g., centrifugal water-oil separators, centrifugal settling devices, dewatering centrifuges), decanters, induced gas floatation such using microbubble technology, and skimming equipment.

In some embodiments, after removing the at least a portion of the iron sulfide scale, a bulk density of the fluid in the low-pressure gas well is reduced by at least 15%, such as at least about 25%, at least about 35%, at least about 45%, or at least about 50% based on an initial bulk density of the fluid before the introduction, separately or together, of the foaming agent, the iron sulfide dissolver, and the corrosion inhibitor. In some embodiments, after removing the at least a portion of the iron sulfide scale, a bulk density of the fluid in the low-pressure gas well is reduced by at least about 50% based on an initial bulk density of the fluid before the introduction, separately or together, of the foaming agent, the iron sulfide dissolver, and the corrosion inhibitor.

In some embodiments, after removing the at least a portion of the iron sulfide scale, a hydrostatic pressure of the fluid in the low-pressure gas well is reduced by at least 15%, such as at least about 25%, at least about 35%, at least about 45%, or at least about 50% based on an initial hydrostatic pressure of the fluid before the introduction, separately or together, of the foaming agent, the iron sulfide dissolver, and the corrosion inhibitor. In some embodiments, after removing the at least a portion of the iron sulfide scale, a hydrostatic pressure of the fluid in the low-pressure gas well is reduced by at least about 50% based on an initial hydrostatic pressure of the fluid before the introduction, separately or together, of the foaming agent, the iron sulfide dissolver, and the corrosion inhibitor.

At steps 108 and 110, the method 100 further includes monitoring a concentration of the iron sulfide scale in the bottom of the low-pressure gas well; and in response to the concentration of the iron sulfide scale subceeding a threshold concentration, stopping the introduction, separately or together, of the foaming agent, the iron sulfide dissolver, and the corrosion inhibitor into the low-pressure gas well.

### EXAMPLES

The following examples demonstrate compositions and methods for iron sulfide scales from low-pressure gas wells, as described herein. The examples are provided solely for illustration and are not to be construed as limitations of the present disclosure, as many variations thereof are possible without departing from the spirit and scope of the present disclosure.

### Example 1: Deposit Compositions

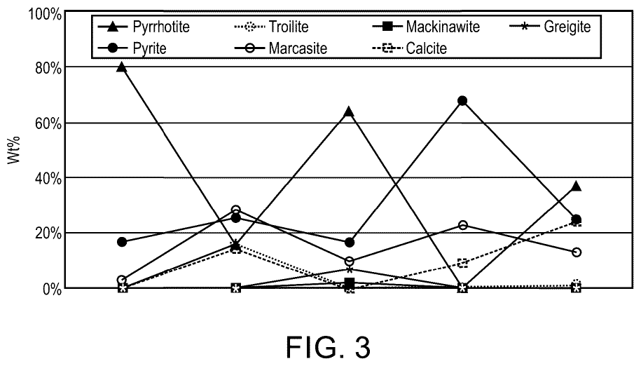

FIG. 3 and Table 1 show the results of samples collected from sand bailer runs in five wells at varying depths, along with the H₂S and CO₂ contents of the produced gases. Two types of deposits were identified in these samples, e.g., FeS and calcite. Samples from wells B1 and B3 contained only FeS, while samples from the other three wells contained 9%, 14%, and 24% calcite, respectively.

FeS was primarily present in the forms of pyrrhotite and iron disulfides (pyrite and marcasite). Pyrite and marcasite were detected in all five samples, with their combined weight percentages ranging from 20% in well B1 to 91% in well B4. Pyrrhotite was found in four samples, with weight percentages ranging from 16% in well B2 to 80% in well B1. Troilite was detected exclusively in the sample from well B2, and trace amounts of mackinawite and greigite were observed in the deposits from well B3.

TABLE 2
Deposit composition of bailer samples
collected from downhole tubular.

| Well name | Well B1 | Well B2 | Well B3 | Well B4 | Well B5 |
|---|---|---|---|---|---|
| H₂S (mole %) | 2.9 | 2.5 | 5.0 | 3.0 | 4.4 |
| CO₂ (mole %) | 0.5 | 2.5 | 3.0 | 4.0 | 3.7 |
| Deposit | 5295 | 10300 | 12000 | 12730 | 12800 |
| depth (ft) | | | | | |

### Example 2: Compositions and Methods of Removing FeS Scales

As described in the present disclosure, FeS deposit in low-pressure wells were addressed by utilizing dual- and/or multi-functional compositions. These functionalities were achieved by incorporating, e.g., foaming agents, which facilitate foam formation, into FeS dissolvers and/or sour corrosion inhibitors. When these dual- and/or multi-functional compositions were applied in treating low-pressure wells, foam was generated in the spent chemicals upon resuming production. The interaction between the produced gas and the spent chemical reduces the bulk density of the fluid in the tubing column and lowers hydrostatic pressure, resulting in reviving the wells or restoring them to pre-treatment productivity levels.

These dual- and/or multi-functional compositions were formulated by combining foaming agents with either dissolver chemicals or corrosion inhibition chemicals to create dual-functional properties. Alternatively, they can incorporate all three types of compounds-foaming agents, dissolvers, and corrosion inhibitors into a single formulation to achieve triple-functional properties.

Additionally, compositions and methods of the present disclosure can be applied in subsurface treatment by pumping these dual- and/or multi-functional chemicals, at the wellhead using a pumping truck or deploying it via coiled tubing to the desired depth.

The dual-function compositions containing foaming agents and corrosion inhibitors were tested for wells with little to no FeS deposits on downhole tubulars.

The dual-function compositions containing foaming agents and FeS dissolvers were tested for wells with large FeS deposition,

The tri-functional compositions containing foaming agents, corrosion inhibitors, and FeS dissolvers were tested for wells with moderate amounts of FeS scale.

The foaming agent is a surfactant that facilitates the formation of foam by reducing surface tension of a liquid or increasing its colloidal stability by inhibiting coalescence of bubbles, when present in small amounts, including anionic, nonionic, anionic-nonionic, amphoteric ion, and cationic surfactants. Compounds for this use include fatty betaine and sulfobetaine compositions, such as sodium lauryl sulfate, sodium dodecylbenzenesulfonate, cocamidopropyl betaine, cocamidopropyl hydroxyl sulfobetaine and cocamidopropyl hydroxy sultaine, and the like.

Iron sulfide dissolving compounds (also known as “FeS dissolvers”) include polyamino polycarboxylic chelanting agent such as EDTA, HEDTA, DTPA, GLDA, etc. and other types such as THPS (tetrakis hydroxymethyl phosphonium sulfate).

Corrosion inhibition compounds, or sour corrosion inhibitors, commonly referred to as “corrosion inhibitors,” form a continuous protective layer between the metal surface and reactive fluids, thereby mitigating the attack of corrosive elements. These compounds also adhere to the surface of corroded metal, altering its characteristics and reducing the corrosion rate. In this disclosure, organic compounds containing unsaturated bonds or atoms, such as nitrogen (N), oxygen (O), and sulfur(S), were utilized as corrosion inhibitors. Examples include long-chain primary amines, imidazolines, fatty acids, and phosphate esters. Furthermore, multiple corrosion inhibitors were combined within a single composition to enhance the protection of carbon steel in highly corrosive environments.

The present disclosure provides compositions and methods for downhole batch treatments targeting FeS scales. The dual- and/or multi-functional compositions demonstrate enhanced performance in treating low-pressure gas wells. Beyond effectively mitigating scale and corrosion, the treatment also facilitates the removal of accumulated produced water and hydrocarbon condensate from wellbore regions. This approach not only enhances well productivity but also significantly lowers treatment costs.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

Certain embodiments of this disclosure can be implemented as a composition for downhole batch treatments targeting FeS scales. The composition includes a foaming agent, and one or more chemicals selected from the group consisting of an iron sulfide dissolver, and a corrosion inhibitor. The composition is capable of reducing a bulk density and hydrostatic pressure of a fluid in a low-pressure gas well.

An aspect combinable with any other aspect can include the following features. The composition includes about 0.1 to about 50 wt. % of a foaming agent; about 0.1 to about 70 wt. % of an iron sulfide dissolver; and about 0.1 to about 10 wt. % of a corrosion inhibitor, each wt. % based on a total weight of the composition.

An aspect combinable with any other aspect can include the following features. The composition includes about 1 to about 30 wt. % of a foaming agent; about 1 to about 60 wt. % of an iron sulfide dissolver; and about 1 to about 10 wt. % of a corrosion inhibitor.

An aspect combinable with any other aspect can include the following features. The composition includes about 1 to about 30 wt. % of a foaming agent; about 1 to about 50 wt. % of an iron sulfide dissolver; and about 1 to about 5 wt. % of a corrosion inhibitor.

An aspect combinable with any other aspect can include the following features. The foaming agent is selected from a nonionic surfactant, an anionic surfactant, a cationic surfactant, an anionic-nonionic surfactant, an amphoteric surfactant, or combinations thereof.

An aspect combinable with any other aspect can include the following features. The foaming agent is a fatty betaine or sulfobetaine composition.

An aspect combinable with any other aspect can include the following features. The foaming agent is selected from sodium lauryl sulfate, sodium dodecylbenzenesulfonate, cocamidopropyl betaine, cocamidopropyl hydroxyl sulfobetaine, cocamidopropyl hydroxy sultaine, or combinations thereof.

An aspect combinable with any other aspect can include the following features. The iron sulfide dissolver is selected from an acid-based dissolver, a chelating agent, an oxidizing agent, a thiocarbamate compound, or combinations thereof.

An aspect combinable with any other aspect can include the following features. The iron sulfide dissolver is a polyamino polycarboxylic chelating agent, a quaternary ammonium salt, or a quaternary phosphonium salt.

An aspect combinable with any other aspect can include the following features. The iron sulfide dissolver is a polyamino polycarboxylic chelating agent selected from the group consisting of ethylenediamine tetraacetic acid (EDTA), ethylene glycol tetraacetic acid (EGTA), cyclohexanenediamine tetraacetic acid (CDTA), hydroxyethylenediamine triacetic acid (HEDTA), diethylenetriamine pentaacetic acid (DPTA), dimercaptopropane sulfonic acid (DPMS), glutamic acid diacetic acid (GLDA), dimercaptosuccinic acid (DMSA), ethylene diamine di-ortho-hydroxy-phenyl acetic acid (EDDHA), ethylene diamine di-ortho-hydroxy-para-methyl phenyl acetic acid (EDDHMA), and ethylene diamine di-ortho-hydroxy-para-carboxy-phenyl acetic acid (EDDCHA).

An aspect combinable with any other aspect can include the following features. The iron sulfide dissolver is a polyamino polycarboxylic chelating agent selected from EDTA, HEDTA, DTPA, GLDA, or THPS (tetrakis hydroxymethyl phosphonium sulfate).

An aspect combinable with any other aspect can include the following features. The corrosion inhibitor is selected from the group consisting of a fatty amine, a fatty diamine, a fatty acid, an imidazoline, a phosphate ester, an amide, a thioamide, a thiol, a thioalcohol, and combinations thereof.

An aspect combinable with any other aspect can include the following features. The corrosion inhibitor is a thioamide selected from thiobenzamide, 4-(trifluoromethoxyl) thiobenzamide, 4-(acetoxymethyl) thiobenzamide, 3,4-dimethyl thiobenzamide, 3-(acetoxymethyl) thiobenzamide, 4-(methylthio) thiobenzamide, 4-(acetoxy) thiobenzamide, 3-(acetoxy) thiobenzamide, and 4-(2-methyl-4-thiazolyl) thiobenzamide.

An aspect combinable with any other aspect can include the following features. The corrosion inhibitor is a thioalcohol selected from 2-mercaptoethanol, 3-mercapto-1-propanol, 8-mercapto-1-octanol, 6-mercapto-1-hexanol, and 9-mercapto-1-nonanol.

An aspect combinable with any other aspect can include the following features. The composition includes a solvent selected from an alcohol, a hydrocarbon, a ketone, an ether, an alkylene glycol, a glycol ether, an amide, a nitrile, a sulfoxide, an ester, a polyol, or combinations thereof.

An aspect combinable with any other aspect can include the following features. The corrosion inhibitor is an organic compound that contains unsaturated bonds or atoms, such as N, O, S, selected from long chain primary amines, imidazolines, fatty acids and phosphate esters.

Certain embodiments of this disclosure can be implemented as a method for downhole batch treatments targeting FeS scales. The method of removing an iron sulfide scale from a low-pressure gas well includes introducing, separately or together, a foaming agent, and one or more chemicals selected from the group consisting of an iron sulfide dissolver, and a corrosion inhibitor, into a bottom of a low-pressure gas well comprising a fluid to form a mixture; contacting the mixture with the iron sulfide scale present in the low-pressure gas well, thereby dissolving at least a portion of the iron sulfide scale in the mixture; and removing the at least a portion of the iron sulfide scale dissolved in the mixture by withdrawing the mixture from the low-pressure gas well.

An aspect combinable with any other aspect can include the following features. The iron sulfide scale includes at least one of pyrite, pyrrhotite, troilite, greigite, mackinawite, marcasite, or combinations thereof.

An aspect combinable with any other aspect can include the following features. The iron sulfide scale includes about 0.1 to about 85 wt. % of pyrrhotite; about 5 to about 70 wt. % of pyrite; about 0.1 to about 10 wt. % of troilite; about 0.5 to about 30 wt. % of marcasite; about 0.1 to about 10 wt. % of greigite; and about 0.01 to about 5 wt. % of mackinawite, each wt. % based on a total weight of the iron sulfide scale present in the low-pressure gas well.

An aspect combinable with any other aspect can include the following features. The iron sulfide scale includes about 5 to about 70 wt. % of pyrite; and about 0.5 to about 30 wt. % of marcasite, each wt. % based on a total weight of the iron sulfide scale present in the low-pressure gas well.

An aspect combinable with any other aspect can include the following features. The low-pressure gas well further includes one or more minerals selected from ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, olivine (fayalite), augite, hedenbergite, biotite, hornblende, garnet (almandine), vivianite, jarosite, glauconite, iron chlorite, native iron, and calcite.

An aspect combinable with any other aspect can include the following features. The low-pressure well is selected from a vertical well, a multilateral well, or a horizontal well.

An aspect combinable with any other aspect can include the following features. The low-pressure well has a bottom pressure of less than about 1000 pounds per square inch (psi).

An aspect combinable with any other aspect can include the following features. The fluid includes gaseous hydrocarbons or liquid hydrocarbons.

An aspect combinable with any other aspect can include the following features. After removing the at least a portion of the iron sulfide scale, a bulk density of the fluid in the low-pressure gas well is reduced by at least about 50% based on an initial bulk density of the fluid before the introduction, separately or together, of the foaming agent, the iron sulfide dissolver, and the corrosion inhibitor.

An aspect combinable with any other aspect can include the following features. After removing the at least a portion of the iron sulfide scale, a hydrostatic pressure of the fluid in the low-pressure gas well is reduced by at least about 50% based on an initial hydrostatic pressure of the fluid before the introduction, separately or together, of the foaming agent, the iron sulfide dissolver, and the corrosion inhibitor.

An aspect combinable with any other aspect can include the following features. The introducing is performed by pumping, separately or together, one or more selected from the group consisting of the foaming agent, the iron sulfide dissolver, and the corrosion inhibitor, at a wellhead of the low-pressure gas well or by displacing the fluid at the bottom of the low-pressure gas well, separately or together, with the foaming agent, the iron sulfide dissolver, and the corrosion inhibitor via a coiled tubing.

1. A composition comprising:
a foaming agent, and one or more chemicals selected from the group consisting of an iron sulfide dissolver, and a corrosion inhibitor;
wherein the composition is capable of reducing a bulk density and hydrostatic pressure of a fluid in a low-pressure gas well.

2. The composition of claim 1, comprising:
about 0.1 to about 50 wt. % of a foaming agent;
about 0.1 to about 70 wt. % of an iron sulfide dissolver; and
about 0.1 to about 10 wt. % of a corrosion inhibitor, each wt. % based on a total weight of the composition.

3. The composition of claim 2, comprising:
about 1 to about 30 wt. % of a foaming agent;
about 1 to about 60 wt. % of an iron sulfide dissolver; and
about 1 to about 10 wt. % of a corrosion inhibitor.

4. The composition of claim 2, comprising:
about 1 to about 30 wt. % of a foaming agent;
about 1 to about 50 wt. % of an iron sulfide dissolver; and
about 1 to about 5 wt. % of a corrosion inhibitor.

5. The composition of claim 1, wherein the foaming agent is a fatty betaine or sulfobetaine composition.

6. The composition of claim 1, wherein the foaming agent is selected from sodium lauryl sulfate, sodium dodecylbenzenesulfonate, cocamidopropyl betaine, cocamidopropyl hydroxyl sulfobetaine, cocamidopropyl hydroxy sultaine, or combinations thereof.

7. The composition of claim 1, wherein the iron sulfide dissolver is selected from an acid-based dissolver, a chelating agent, an oxidizing agent, a thiocarbamate compound, or combinations thereof.

8. The composition of claim 1, wherein the iron sulfide dissolver is a polyamino polycarboxylic chelating agent, a quaternary ammonium salt, or a quaternary phosphonium salt.

9. The composition of claim 8, wherein the iron sulfide dissolver is a polyamino polycarboxylic chelating agent selected from EDTA, HEDTA, DTPA, GLDA, or THPS (tetrakis hydroxymethyl phosphonium sulfate).

10. The composition of claim 1, wherein the corrosion inhibitor is selected from the group consisting of a fatty amine, a fatty diamine, a fatty acid, an imidazoline, a phosphate ester, an amide, a thioamide, a thiol, a thioalcohol, and combinations thereof.

11. The composition of claim 1, wherein the corrosion inhibitor is an organic compound that comprises unsaturated bonds or atoms selected from N, O, and S, and wherein the organic compound is selected from long chain primary amines, imidazolines, fatty acids and phosphate esters.

12. A method of removing an iron sulfide scale from a low-pressure gas well, the method comprising:
introducing, separately or together, a foaming agent, and one or more chemicals selected from the group consisting of an iron sulfide dissolver, and a corrosion inhibitor, into a bottom of a low-pressure gas well comprising a fluid to form a mixture;
contacting the mixture with the iron sulfide scale present in the low-pressure gas well, thereby dissolving at least a portion of the iron sulfide scale in the mixture; and
removing the at least a portion of the iron sulfide scale dissolved in the mixture by withdrawing the mixture from the low-pressure gas well.

13. The method of claim 12, wherein the iron sulfide scale comprises at least one of pyrite, pyrrhotite, troilite, greigite, mackinawite, marcasite, or combinations thereof.

14. The method of claim 12, wherein the iron sulfide scale comprises:
about 0.1 to about 85 wt. % of pyrrhotite;
about 5 to about 70 wt. % of pyrite;
about 0.1 to about 10 wt. % of troilite;
about 0.5 to about 30 wt. % of marcasite;
about 0.1 to about 10 wt. % of greigite; and
about 0.01 to about 5 wt. % of mackinawite, each wt. % based on a total weight of the iron sulfide scale present in the low-pressure gas well.

15. The method of claim 14, wherein the iron sulfide scale comprises:
about 5 to about 70 wt. % of pyrite; and
about 0.5 to about 30 wt. % of marcasite, each wt. % based on a total weight of the iron sulfide scale present in the low-pressure gas well.

16. The method of claim 12, wherein the low-pressure gas well further comprises one or more minerals selected from ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, olivine (fayalite), augite, hedenbergite, biotite, hornblende, garnet (almandine), vivianite, jarosite, glauconite, iron chlorite, native iron, and calcite.

17. The method of claim 12, wherein the fluid comprises gaseous hydrocarbons or liquid hydrocarbons.

18. The method of claim 12, wherein after removing the at least a portion of the iron sulfide scale, a bulk density of the fluid in the low-pressure gas well is reduced by at least about 50% based on an initial bulk density of the fluid before the introduction, separately or together, of the foaming agent, the iron sulfide dissolver, and the corrosion inhibitor.

19. The method of claim 12, wherein after removing the at least a portion of the iron sulfide scale, a hydrostatic pressure of the fluid in the low-pressure gas well is reduced by at least about 50% based on an initial hydrostatic pressure of the fluid before the introduction, separately or together, of the foaming agent, the iron sulfide dissolver, and the corrosion inhibitor.

20. The method of claim 12, wherein the introducing is performed by pumping, separately or together, one or more selected from the group consisting of the foaming agent, the iron sulfide dissolver, and the corrosion inhibitor, at a wellhead of the low-pressure gas well or by displacing the fluid at the bottom of the low-pressure gas well, separately or together, with the foaming agent, the iron sulfide dissolver, and the corrosion inhibitor via a coiled tubing.
